(19) United States
(12) Patent Application Publication
(10) Pub. No.: US 2026/0350895 A1
(43) Pub. Date: Nov. 5, 2026

(54) VIDEO GENERATION METHOD AND APPARATUS, MODEL TRAINING METHOD AND APPARATUS, DEVICE, STORAGE MEDIUM, COMPUTER PROGRAM, AND COMPUTER PROGRAM PRODUCT

(71) Applicant: MOORE THREADS TECHNOLOGY CO., LTD., Beijing (CN)

(72) Inventor: Liang YANG, Beijing (CN)

(21) Appl. No.: 19/488,835

(22) PCT Filed: Feb. 27, 2024
(86) PCT No.: PCT/CN2024/078798

§ 371 Date: Nov. 30, 2025

(30) Foreign Application Priority Data
Jun. 2, 2023 (CN) 202310646787.8

(51) Int. Cl. G06T 13/20; G06T 7/11; G06T 11/60; G06T 13/40; G06T 13/80; G10L 15/06; G10L 15/16; G10L 25/57; G10L 25/63

(52) U.S. Cl. CPC G06T 13/205; G06T 7/11; G06T 11/60; G06T 13/40; G06T 13/80; G10L 15/063; G10L 15/16; G10L 25/57; G06T 2207/10016; G06T 2207/20081; G06T 2207/20084; G06T 2207/20221; G06T 2207/30201; G10L 25/63

(57) ABSTRACT

Embodiments of the present disclosure provide a video generation method and apparatus, a model training method and apparatus, a device, a storage medium, a computer program, and a computer program product. The video generation method comprises: acquiring a first voice feature and a first head feature of a first character, wherein the first head feature is obtained by performing mask processing on a mouth area of the first character in a first video, and the first voice feature is obtained on the basis of a first audio; on the basis of the first head feature and the first voice feature, generating a second video containing the first character, wherein a speaking action of the first character in the second video matches the first audio.

### CROSS-REFERENCE TO RELATED APPLICATION(S)

The present application is based on and claims the priority to Chinese Patent Application No. 202310646787. 8, filed on Jun. 2, 2023 and entitled “VIDEO GENERATION METHOD AND APPARATUS, MODEL TRAINING METHOD AND APPARATUS, DEVICE AND STORAGE MEDIUM”. The entire content of the Chinese Patent Application is incorporated herein by reference.

### TECHNICAL FIELD

The present disclosure relates to, but is not limited to, the technical field of artificial intelligence, and particularly relates to a method and an apparatus for video generation, a method and an apparatus for model training, a device, a storage medium, a computer program and a computer program product.

### BACKGROUND

Voice-driven speaker synthesis refers to driving the facial movements of the target character through voice information to obtain a realistic speaking video of the target character. With the development of artificial intelligence technology, the application of voice-driven speaker synthesis is more and more widespread. However, in the related art, in the speaking video generated by video driving, the speaking behavior of the character is not reasonable and realistic enough, resulting in that the video quality is not high enough.

### SUMMARY

In view of the above, the embodiments of the present disclosure at least provide a method and an apparatus for video generation, a method and an apparatus for model training, a device, a storage medium, a computer program and a computer program product, which can improve the rationality and reality of overall speaking behavior of a character in a generated video, and thus improve the quality of the generated video.

The technical solution of the embodiments of the present disclosure is implemented as follows.

An embodiment of the present disclosure provides a method for video generation, the method is performed by an electronic device, and the method includes the following operations.

A first speech feature and a first head feature of a first character are acquired. The first head feature is obtained by performing mask processing on a mouth area of the first character in a first video, and the first speech feature is obtained based on a first audio.

A second video including the first character is generated based on the first head feature and the first speech feature. A speaking behavior of the first character in the second video matches the first audio.

An embodiment of the present disclosure provides a method for model training, the method is performed by an electronic device, and the method includes the following operations.

First speech training data and first head training data of a second character are acquired. The first head training data is obtained by performing mask processing on a mouth area of the second character in a training video, and the first speech training data is obtained based on a training audio.

The first speech training data and the first head training data are inputted into a model to be trained to obtain a fifth video including the second character.

A target loss is determined using the fifth video, and parameter tuning is performed on the model to be trained based on the target loss.

It is determined that training of the model to be trained is completed in case where a speaking action of the second character in the fifth video matches the training audio.

An embodiment of the present disclosure provides an apparatus for video generation, and the apparatus includes a first acquiring portion and a first generating portion.

The first acquiring portion is configured to acquire a first speech feature and a first head feature of a first character. The first head feature is obtained by performing mask processing on a mouth area of the first character in a first video, and the first speech feature is obtained based on a first audio.

The first generating portion is configured to generate a third video including the first character based on the first head feature and the first speech feature. A speaking behavior of the first character in the third video matches the first audio.

An embodiment of the present disclosure provides an apparatus for model training, the apparatus includes a second acquiring portion, a second generating portion, a tuning portion and a first determining portion.

The second acquiring portion is configured to acquire first speech training data and first head training data of a second character. The first head training data is obtained by performing mask processing on a mouth area of the second character in a training video, and the first video training data is obtained based on a training audio.

The second generating portion is configured to input the first speech training data and the first head training data into a model to be trained to obtain a fifth video including the second character.

The tuning portion is configured to determine a target loss by using the fifth video and perform parameter tuning on the model to be trained based on the target loss.

A first determining portion is configured to determine that training of the model to be trained is completed in case where a speaking behavior of the second character in the fifth video matches the training audio.

An embodiment of the present disclosure provides a computer device including a processor and a memory having a computer program stored thereon which is able to run on the processor. The program, when executed by the processor, implements a part or all of the operations of the method for video generation or the method for model training described above.

An embodiment of the present disclosure provides a computer-readable storage medium on which a computer program is stored. The computer program, when executed by a processor, implements a part or all of the operations of the method for video generation or the method for model training described above.

An embodiment of the present disclosure provides a computer program including computer-readable codes. When the computer-readable codes are run in a computer device, a processor in the computer device implements a part or all of the operations for implementing the methods described above.

An embodiment of the present disclosure provides a computer program product including a computer program that, when executed by a processor, implements the method described above.

An embodiment of the present disclosure provides a computer program product including a non-transitory computer-readable storage medium for storing a computer program that, when read and executed by a computer, implements the method described above.

In an embodiment of the present disclosure, a first speech feature and a first head feature of a first character are acquired, a second video including the first character is generated based on the first head feature and the first speech feature, and the speaking behavior of the first character in the second video is matched with the first audio. In this way, since the first head feature is obtained by performing mask processing on the mouth area of the first character in the first video, the first head feature is not affected by the mouth area and is more reasonable and accurate, and the first speech feature is obtained based on the first audio. Therefore, in the second video generated based on the first head feature and the first speech feature, the appearance and posture of the head of the first character is more accurate, and the appearance and posture of the head is more matched with the first audio, and the overall speaking behavior of the character is more reasonable and realistic, thereby improving the rationality and reality of the overall speaking behavior of the first character in the generated second video, and improving the quality of the generated second video.

It should be understood that the above general description and the following detailed description are exemplary and explanatory only, and do not limit the present disclosure.

### BRIEF DESCRIPTION OF THE DRAWINGS

The accompanying drawings herein are incorporated into and constitute a part of the specification, illustrate embodiments consistent with the present disclosure, and together with the specification, are used to explain technical solutions of the present disclosure.

FIG. 1 is a first schematic flowchart of an implementation of a method for video generation according to an embodiment of the present disclosure.

FIG. 2 is a second schematic flowchart of an implementation of a method for video generation according to an embodiment of the present disclosure.

FIG. 3 is a third schematic flowchart of an implementation of a method for video generation according to an embodiment of the present disclosure.

FIG. 4 is a first schematic flowchart of an implementation of a method for model training according to an embodiment of the present disclosure.

FIG. 5 is a second schematic flowchart of an implementation of a method for model training according to an embodiment of the present disclosure.

FIG. 6A is a fourth schematic flowchart of an implementation of a method for video generation according to an embodiment of the present disclosure.

FIG. 6B is a schematic diagram of an implementation of training a content encoder and an emotion encoder using a cross-reconstruction decoupling network according to an embodiment of the present disclosure.

FIG. 7A is a schematic structural composition diagram of an apparatus for video generation according to an embodiment of the present disclosure.

FIG. 7B is a schematic structural composition diagram of an apparatus for model training according to an embodiment of the present disclosure.

FIG. 8 is a schematic diagram of a hardware entity of a computer device according to an embodiment of the present disclosure.

### DETAILED DESCRIPTION

In order to make the object, technical solution, and advantages of the present disclosure clearer, the technical solution of the present disclosure is described in further detail below with reference to the accompanying drawings and the embodiments. The described embodiments are not regarded as a limit to the present disclosure. All other embodiments obtained by those skilled in the art without creative work fall within the scope of protection of the present disclosure.

In the following description, a subset of all possible embodiments is described in the “some embodiments”, but it is understood that the “some embodiments” may be the same subset or different subsets of all possible embodiments, and may be combined with each other without conflict.

The terms “first/second/third” are merely to distinguish similar objects and does not represent a specific order of the objects, and it is understood that an order described by “first/second/third” may be interchanged where applicable, so that the embodiments of the present disclosure described herein can be implemented in an order other than that illustrated or described herein.

Unless otherwise defined, all technical and scientific terms used herein have the same meaning as commonly understood by those skilled in the art belonging to the present disclosure. The terms used herein are for the purpose of describing the disclosure, rather than limiting the disclosure.

In the related art, a feature encoder is usually used to extract features of the reference video and the driving audio respectively to obtain features in the video mode and features in the audio mode, and the features in the video mode and the features in the audio mode are combined to decode at the feature decoding end to generate video matching the driving audio. However, in the method for video generation of the related art, the modeling for the appearance and posture of the head is neglected, which makes the appearance and posture of the head of the character in the generated video not fit well with the driving audio. Therefore, the speaking behavior of the character is not reasonable and realistic enough, and thus the video quality is not high.

In view of this, the embodiments of the present disclosure provide a method for video generation that may be executed by a processor of a computer device. The computer device may refer to a device having data processing capabilities such as a server, a notebook computer, a tablet computer, a desktop computer, a smart TV, a set-top box, a mobile device (for example, a mobile phone, a portable video player, a personal digital assistant, a dedicated messaging device, a portable game device), and the like.

In order to better understand the embodiments of the present disclosure, some terms related to the embodiments of the present disclosure will be explained below.

A first video is a preset video including a first character.

A second video is a video to be generated including a first character.

A third video is a video obtained by performing mask processing on a mouth area of a first character in the first video.

A fourth video is a video to be generated including a first character, and a second video can be obtained by performing image fusion on a face area and a background area in at least one video frame in the fourth video.

A first audio is a preset audio for driving the first character to speak in the second video to be generated.

A training video is a video used to train the model, and the training video contains a second character.

A fifth video is a video containing a second character generated during the model training process.

A sixth video is a video obtained by performing mask processing on the mouth area of the second character in the training video.

A training audio is a preset audio for driving the second character to speak in the fifth video to be generated.

A reference video is a preset video tag corresponding to the training audio, the reference video includes a second character, and the speaking behavior of the second character in the reference video matches the training audio.

FIG. 1 is a first schematic flowchart of an implementation of a method for video generation according to an embodiment of the present disclosure. As shown in FIG. 1, the method may include the following steps S101 to S102.

At step S101, a first speech feature and a first head feature of a first character are acquired. The first head feature is obtained by performing mask processing on a mouth area of the first character in a first video, and the first speech feature is obtained based on a first audio.

Here, the first audio may be a preset audio for driving a character, in a second video to be generated, to speak. Any suitable speech content may be included in the first audio. In implementation, those skilled in the art may acquire the first audio in any suitable manner according to the actual situation, which is not limited in the embodiments of the present disclosure. For example, the first audio may be an audio collected in advance, or the first audio may be an audio synthesized according to a set text.

The first speech feature may be obtained by performing feature extraction on the first audio. In implementation, any suitable feature extraction network may be used to perform feature extraction on the first audio, so as to obtain a first speech feature, which is not limited in the embodiments of the present disclosure. The feature extraction network used in the feature extraction of the first audio may include, but is not limited to, at least one of a Convolutional Neural Networks (CNN), a Recurrent Neural Network (RNN), a Transformer encoder, and the like.

In some embodiments, the first speech feature may include, but is not limited to, at least one of a first content feature characterizing speech content, a first emotion feature characterizing an emotion contained in speech, and the like.

The first video may include at least one video frame including the first character. It is understood that the first video may include a plurality of consecutive video frames collected or synthesized in advance, and the first video may also include at least one video frame sampled from the plurality of consecutive video frames.

The first head feature may be obtained by performing mask processing on the mouth area of the first character in the first video. The first head feature may include, but is not limited to, at least one of a first head movement feature characterizing a head motion of the first character, a first non-mouth area feature characterizing an area of the head except the mouth area, a first expression feature characterizing a facial expression of the first character, and the like.

In some embodiments, mask processing may be performed on the mouth area of the first character in the first video to obtain a third video, and a first head feature of the first character may be extracted from the third video.

Here, mask processing may be performed on the mouth area of the first character included in each video frame of the first video to obtain the third video.

In some embodiments, the mouth area of the first character in each video frame of the first video may be detected, and the mask processing may be performed on the corresponding mouth area in each video frame. In implementation, the target detection algorithm may be used to identify key points of the mouth in the video frame to obtain the mouth area of the first character in the video frame.

In some embodiments, the mouth area of the first character in at least one video frame of the first video may be detected, the mouth area corresponding to respective video frame of the first video may be determined according to the mouth area of the first character in the at least one video frame, and the mask processing may be performed on the mouth area in the respective video frame. In implementation, those skilled in the art may determine the mouth area corresponding to respective video frame in the first video based on the mouth area of the first character in the at least one video frame in any appropriate manner according to the actual situation. For example, a union or intersection of the detected mouth areas of the first character in the at least one video frame may be determined as the mouth area corresponding to respective video frame in the first video. For another example, the detected mouth area of the first character in one video frame may be determined as the mouth area corresponding to respective video frame in the first video.

Feature extraction is performed on the third video by using any suitable feature extraction network, and the first head feature of the first character may be obtained. Since the mask processing is performed on the mouth area of the first character included in respective video frame in the third video, the feature extraction on the third video may obtain a head feature (that is, a first head feature) except for the mouth area of the first character in the third video.

In implementation, the feature extraction network used for the feature extraction of the third video may include, but is not limited to, at least one of a CNN, an RNN, a Transformer-based encoder network, and the like. For example, a VGG network (such as VGG16, VGG19, etc.) may be used to perform feature extraction on the third video to obtain the first header feature.

It is to be understood that the operations of obtaining the first speech feature by feature extraction of the first audio, obtaining the third video by performing mask processing on the mouth area of the first character in the first video, and extracting the first head feature of the first character from the third video may be executed by a processor that executes the method for video generation or by another processor, which are not limited herein.

At step S102, a second video including the first character is generated based on the first head feature and the first speech feature. A speaking behavior of the first character in the second video matches the first audio.

Here, a video frame sequence including the first character may be rendered and generated based on the first head feature and the first speech feature, to obtain a second video, and the speaking behavior of the first character in the second video matches the first audio. The speaking behavior of the first character may include, but is not limited to, at least one of a mouth shape, a facial expression, a head movement, and the like.

In implementation, the generated second video may be either silent or with sound, which is not limited in the embodiments of the present disclosure. For example, in a case where the generated second video is silent, those skilled in the art may add the first audio into the second video according to an actual application scenario to obtain a second video with sound.

In some embodiments, after the video frame sequence including the first character is rendered and generated, the video frame sequence may be synthesized with the first audio to obtain the synthesized second video with sound.

In some implementations, a pre-trained rendering generation network may be used to render and generate a second video based on the first head feature and the first speech feature. Here, the rendering generation network may be any suitable neural network adopted by those skilled in the art according to the actual situation, which is not limited in the embodiments of the present disclosure.

In some embodiments, the first head feature and the first speech feature may be fused to obtain the first fusion feature, and the second video may be rendered and generated based on the first fusion feature using a pre-trained rendering generation network.

It can be understood that the first head feature may be used to render the image portion corresponding to the non-mouth area in respective video frame of the second video, and the first speech feature may be used to generate an image portion corresponding to the mouth area in respective video frame of the second video. Therefore, a second video including a first character may be generated based on the first head feature and the second head feature. In implementation, the image portion corresponding to the non-mouth area and the image portion corresponding to the mouth area in respective video frame of the second video may be rendered separately and fused together, or may be rendered together.

In an embodiment of the present disclosure, a first speech feature and a first head feature of a first character are acquired, a second video including the first character is generated based on the first head feature and the first speech feature, and the speaking behavior of the first character in the second video is matched with the first audio. In this way, since the first head feature is obtained by performing mask processing on the mouth area of the first character in the first video, the first head feature is not affected by the mouth area and is more reasonable and accurate, and the first speech feature is obtained based on the first audio. Therefore, in the second video generated based on the first head feature and the first speech feature, the appearance and posture of the head of the first character is more accurate, and the appearance and posture of the head is more matched with the first audio, and the overall speaking behavior of the character is more reasonable and realistic, thereby improving the rationality and reality of the overall speaking behavior of the first character in the generated second video, and improving the quality of the generated second video.

In some embodiments, the first head feature includes a first non-mouth area feature and a first head movement feature, the first non-mouth area feature is obtained by performing encoding processing on a third video, and the third video is obtained by performing mask processing on the mouth area of the first character in the first video, and the first head movement feature is obtained by mapping the first non-mouth area feature to a preset movement feature space.

In some embodiments, the above-described process of extracting the first head feature of the first character from the third video may include the following steps S111 to S112.

At step S111, encoding processing is performed on the third video to obtain the first non-mouth area feature.

Here, any suitable encoder may be used to perform encoding processing on the third video to extract visual features except for the mouth area of the first character in the third video, to obtain a first non-mouth area feature.

In implementation, the encoder for performing encoding processing on the third video may be pre-trained or may not be trained after initialization, which is not limited in the embodiments of the present disclosure.

In some embodiments, the trained first encoder may be used to perform encoding processing on the respective video frame in the third video to obtain a first non-mouth area feature, and the first non-mouth area feature may include a non-mouth area sub-feature corresponding to each video frame. The first encoder may include, but is not limited to, at least one of a CNN-based encoder, an RNN-based encoder, a Transformer-based encoder, and the like. For example, the first encoder may include an encoder based on a VGG network (e.g., VGG 16, VGG 19, etc.).

At step S112, the first non-mouth area feature is mapped to a preset movement feature space, to obtain the first head movement feature.

Here, the movement feature space may be used to define the motion posture representation of a character's head. Using the set mapping sub-network, the first non-mouth area feature may be mapped into the movement feature space to obtain the first head movement feature representing the head movement of the first character. The mapping sub-network may include, but is not limited to, at least one of a Mapping layer, an Embedding layer, a fully connected layer, and the like, which is not limited in the embodiments of the present disclosure.

In implementation, the movement feature space may be preset by those skilled in the art according to the actual situation. For example, the dimensions of the movement feature space may be 12 dimensions, and each head movement feature in the movement feature space may be a 12-dimensional vector, and each head movement feature may include a 9-dimensional rotation matrix, a 2-dimensional translation representation, and a 1-dimensional scale representation.

In the above embodiment, encoding processing is performed on the third video to obtain the first non-mouth area feature, and the first non-mouth area feature is mapped to a preset movement feature space to obtain a first head movement feature. In this way, the visual feature of the non-mouth area of the first character and the head movement of the first character may be modeled respectively, so that the extracted first non-mouth area feature may characterize the visual feature of the non-mouth area of the first character, and the extracted first head movement features may characterize the head movement of the first character, thereby further improving the rationality and reality of the speaking behavior of the first character in the generated second video, and improving the quality of the generated second video.

In some embodiments, the above step S102 may include steps S121 to S122 as follows.

At step S121, a fourth video including the first character is generated based on the first head feature and the first speech feature.

At step S122, image fusion is performed on a face area and a background area in at least one fourth video frame in the fourth video to obtain the second video.

Here, after the fourth video including the first character is rendered and generated based on the first head feature and the first speech feature, the image fusion algorithm may be used to perform image fusion on the face area and the background area of at least one fourth video frame in the fourth video to obtain the second video.

In implementation, any suitable image fusion method may be used to perform image fusion on the face area and the background area in at least one fourth video frame in the fourth video, which is not limited in the embodiments of the present disclosure. For example, the image fusion method may include, but is not limited to, at least one of Poisson fusion, Laplace pyramid fusion, multi-band fusion, and the like.

In the above embodiment, a fourth video including a first character is generated based on the first head feature and the first speech feature. The image fusion is performed on a face area and a background area in at least one fourth video frame in the fourth video to obtain a second video. In this way, the transition between the face area and the background area of each video frame in the generated second video may be natural, thereby reducing subtle artifacts in the second video and reducing subtle changes in the appearance of the first character in respective video frames of the second video, and thus improving the consistency of the appearance of the first character in the respective video frame of the second video.

The embodiments of the present disclosure provide a method for video generation, which may be performed by a processor of a computer device. FIG. 2 is a first schematic flowchart of an implementation of a method for video generation according to an embodiment of the present disclosure. As shown in FIG. 2, the method may include the following steps S201 to S203.

At step S201, a first speech feature and a first head feature of a first character are acquired. The first head feature is obtained by performing mask processing on a mouth area of the first character in a first video, and the first speech feature is obtained based on a first audio.

Here, step S201 corresponds to step S101 in the foregoing embodiment, and in implementation of step 201, reference may be made to the embodiment of step S101.

At step S202, the first head feature and the first speech feature are fused to obtain a first fusion feature.

Here, the process of fusing the first head feature and the first speech feature may include, but is not limited to, at least one of concatenation, convolutional fusion and the like of the first head feature and the first speech feature.

In some embodiments, the first head feature and the first speech feature may be fused integrally to obtain the first fusion feature.

In some implementations, the first header feature may include respective first header sub-feature corresponding to each video frame in the first video, the first speech feature may include respective first speech sub-feature corresponding to each video frame in the first video, and the first fusion feature may include respective first fusion sub-feature corresponding to each video frame in the first video. In implementation, the all first header sub-features in the first header feature may be frame-level fused with the respective first speech sub-features in the first speech feature to obtain the first fusion feature. For example, for each video frame in the first video, the first header sub-feature corresponding to the video frame may be concatenated with the first speech sub-feature corresponding to the video frame to obtain a first fusion sub-feature corresponding to the video frame, thereby obtaining a first fusion feature.

At step S203, a second video is generated based on the first fusion feature, and the speaking behavior of the first character in the second video matches the first audio.

In some implementations, a pre-trained rendering generation network may be used to render and generate a second video based on the first fusion feature. Here, the rendering generation network may be any suitable neural network adopted by those skilled in the art according to the actual situation, which is not limited in the embodiments of the present disclosure. For example, the rendering generation network may include, but is not limited to, an encoder-decoder network, a decoder network, or a generative adversarial network, etc.

In the embodiment of the present disclosure, the first head feature and the first speech feature are first fused to obtain the first fusion feature, and the second video may be generated more accurately based on the first fusion feature, so that the speaking behavior of the first character in the second video may be matched with the first audio.

In some embodiments, the first speech feature includes a first content feature and a first emotion feature. The above step S202 may include the following step S211.

At step S211, the first header feature and the first content feature are fused to obtain a first fusion feature.

Here, the first speech feature may include a first content feature characterizing speech content, and a first emotion feature characterizing emotions included in the speech. In implementation, the first content feature and the first emotion feature may be extracted from the first audio.

In some embodiments, two encoders may be used to perform feature extraction on the first audio, to obtain a first content feature and a first emotion feature respectively.

The operation of fusing the first header feature and the first content feature may include, but is not limited to, at least one of performing concatenation, convolutional fusing, and the like on the first header feature and the first content feature.

In some embodiments, the first header feature and the first content feature may be integrally fused to obtain the first fusion feature.

In some embodiments, the multiple first header sub-features corresponding to different video frames in the first header feature may be frame-level fused with the first content sub-features corresponding to different video frames in the first content feature to obtain the fused first fusion feature.

The above step S203 may include the following step S212.

At step S212, the second video is generated based on the first fusion feature and the first emotion feature.

Here, a pre-trained rendering generation network may be used to render and generate a second video based on the first fusion feature and the first emotion feature. For example, the rendering generation network may include, but is not limited to, at least one of an encoder-decoder network, a generator in a generative adversarial network, and the like.

In some embodiments, encoding processing may be performed on the first fusion feature and the first emotion feature to obtain feature encoding, and decoding processing is performed on the feature encoding to generate a second video. For example, the rendering generation network may include a fourth encoder and a first decoder, and encoding processing may be performed on the first fusion feature and the first emotion feature by the fourth encoder to obtain feature encoding, and decoding processing is performed on the feature encoding by the first decoder to generate a second video.

In some embodiments, encoding processing may be performed on the first fusion feature to obtain a feature encoding, and decoding processing is performed on the feature encoding and the first emotion feature to generate the second video.

In the above embodiment, the first content feature and the first emotion feature may be extracted from the first audio. The first head feature and the first content feature are fused to obtain a first fusion feature, and a second video is generated based on the first fusion feature and the first emotion feature. In this way, the content feature and the emotion feature in the first audio may be decoupled, so that while the first content feature drives the generation of the mouth movement, the facial expression of the first character may be adaptively adjusted in combination with the first emotion feature, and the appearance and posture of the head of the first character in the generated second video may be matched with the speech content and emotion in the first audio.

In some embodiments, the above step S212 may include steps S221 to S222 as follows.

At step S221, encoding processing is performed on the first fusion feature to obtain the encoded first fusion feature.

At step S222, decoding processing is performed on the first emotion feature and the encoded first fusion feature to obtain the second video.

In some embodiments, the fourth encoder may be used to perform encoding processing on the first fusion feature to obtain the encoded first fusion feature, and the first decoder may be used to perform decoding processing on the first emotion feature and the encoded first fusion feature to obtain the first video.

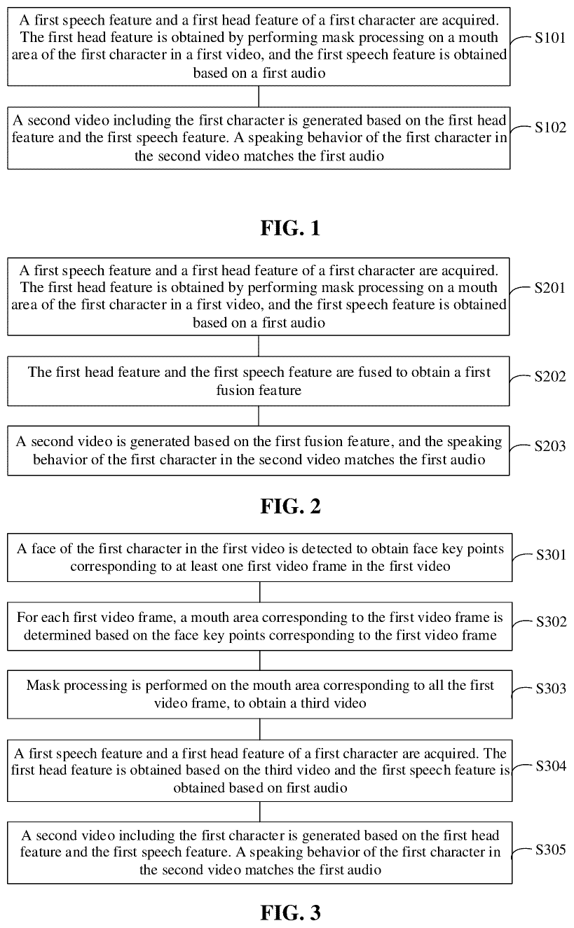

The embodiments of the present disclosure provide a method for video generation, which may be performed by a processor of a computer device. FIG. 3 is a first schematic flowchart of an implementation of a method for video generation according to an embodiment of the present disclosure. As shown in FIG. 3, the method may include the following steps S301 to S305.

At step S301, a face of a first character in a first video is detected to obtain face key points corresponding to at least one first video frame in the first video.

At step S302, for each first video frame, a mouth area corresponding to the first video frame is determined based on the face key points corresponding to the first video frame.

At step S303, mask processing is performed on the mouth area corresponding to each first video frame to obtain a third video.

Here, a pre-trained face detection network may be used to detect the face of the first character in at least one first video frame of the first video, to obtain the face key points included in each of the at least one first video frame.

The face key points may include, but are not limited to, at least one of mouth key points, eye key points, nose key points, eyebrow key points, and the like. It can be understood that, for each first video frame, various areas of the face of the first character in the first video frame may be determined according to the face key points in the first video frame. For example, a mouth area of the first character in the first video frame may be determined according to mouth key points included in the first video frame, and an eye area of the first character in the first video frame may be determined according to the eye key points included in the first video frame.

In some embodiments, for each first video frame in the first video, the mouth area of the first character in the first video frame may be separated according to the mouth key points in the first video frame, to obtain the mouth area and the non-mouth area corresponding to the first video frame.

For each first video frame, after the mouth area corresponding to the first video frame is determined, mask processing may be performed on the mouth area corresponding to the first video frame, to obtain a masked first video frame. Therefore, a third video including all masked first video frame is obtained.

At step S304, a first speech feature and a first head feature of a first character are acquired. The first head feature is obtained based on the third video and the first speech feature is obtained based on first audio.

Here, step S304 corresponds to step S101 in the foregoing embodiment, and in implementation of step S304, reference may be made to the embodiment of step S101.

At step S305, a second video including the first character is generated based on the first head feature and the first speech feature. A speaking behavior of the first character in the second video matches the first audio.

Here, steps S304 to S305 correspond to steps S101 to S102 in the foregoing embodiment, respectively, and in implementation of steps S304 to S305, reference may be made to the embodiments of steps S101 to S102.

In an embodiment of the present disclosure, the face of the first character in a first video is detected to obtain face key points corresponding to at least one first video frame in the first video. For each first video frame, the mouth area corresponding to the first video frame is determined based on the face key points corresponding to the first video frame. Mask processing is performed on the respective mouth area corresponding to each first video frame to obtain the third video. In this way, the mask processing may be quickly and accurately performed on the mouth area of the first character in the first video to obtain the third video.

In some embodiments, the method may further include the following step S311.

At step S311, a first reference video frame is determined from the first video.

Here, the first reference video frame may be determined from the first video in any suitable manner, which is not limited in the embodiments of the present disclosure. For example, a first video frame having the highest image quality in the first video may be determined as a first reference video frame. As another example, the first video frame in the first video may be determined as a first reference video frame. For another example, one video frame may be randomly selected from the first video as the first reference video frame.

The above step S305 may include the following step S312.

At step S312, a second video including the first character is generated based on the first head feature, a first identity feature of the first character and the first speech feature. The first identity feature is extracted from the first reference video frame.

Here, identity information of the first character in the first reference video frame may be identified to obtain the first identity feature of the first character. A sequence of video frames including the first character may be rendered and generated based on the first head feature, the first identity feature, and the first speech feature, to obtain a third video.

In implementation, a pre-trained rendering generation network may be used to render and generate a second video based on the first head feature, the first identity feature and the first speech feature.

In the above embodiment, the first reference video frame is determined from the first video, and the first identity feature of the first character is extracted from the first reference video frame. The second video including a first character is generated based on the first head feature, the first identity feature and the first speech feature. In this way, the first identity feature of the first character is considered in the process of generating the second video, so that the overall visual features of the first character in the second video and the identity consistency of the first character in respectively video frames may be maintained, and the method for video generation may be applied to the generation scenes of the second video corresponding to different characters.

In some embodiments, the face key points include a first key point characterizing an upper lip, and a second key point characterizing a lower lip. The above step S311 may include the following steps S321 to S322.

At step S321, for each first video frame, a closure degree of the mouth in the first video frame is determined based on the first key point and the second key point corresponding to the first video frame.

Here, the distance between the upper lip and the lower lip of the first character in the first video frame may be determined according to the distance between the first key point and the second key point corresponding to the first video frame, so that the closure degree of mouth in the first video frame may be determined. It is understood that the smaller the distance between the upper lip and the lower lip, the greater the closure degree of the mouth, and the larger the distance between the upper lip and the lower lip, the lower the closure degree of the mouth.

In some embodiments, the number of the first key point is one, the number of the second key point is also one, and the closure degree of mouth in the first video frame may be determined according to the distance between the first key point and the second key point corresponding to the first video frame. The closure degree of mouth in the first video frame is inversely proportional to the distance between the first key point and the second key point corresponding to the first video frame. For example, a reciprocal of the distance between the first key point and the second key point corresponding to the first video frame may be determined as the closure degree of mouth in the first video frame.

In some embodiments, the number of first key points is more than one, the number of second key points is also more than one, and there is a one-to-one correspondence between the plurality of first key points and the plurality of second key points, and the closure degree of mouth in the first video frame may be determined according to the distance between the plurality of first key points and the corresponding multiple second key points in the first video frame, respectively. For example, the closure degree of mouth in the first video frame may be determined from an average value of distances between the plurality of first key points and the corresponding second key points in the first video frame, respectively. As another example, the closure degree of mouth in the first video frame may be determined according to the minimum value of the distances between the plurality of first key points and the corresponding second key points in the first video frame.

At step S322, a first reference video frame with the greatest closure degree of mouth is determined from the first video.

In some embodiments, one first video frame with the greatest closure degree of the mouth in the first video may be determined as the first reference video frame.

In some embodiments, one first video frame may be selected from a plurality of first video frames with the greatest closure degree of the mouth in the first video, as the first reference video frame.

In the above embodiment, for each first video frame, the closure degree of the mouth in the first video frame is determined based on the first key point and the second key point corresponding to the first video frame, and a first reference video frame with a greatest closure degree of the mouth (i.e., the mouth movement range of the first character is smaller) may be determined from the first video based on the closure degrees of the mouth in the all first video frames, and an effect of the mouth movement in the first reference video frame on identifying the identity information may be reduced. In this way, in the process of extracting the first identity feature of the first character from the first reference video frame, the identification of the identity information of the character can be focused on, thereby improving the accuracy of the extracted first identity feature of the first character.

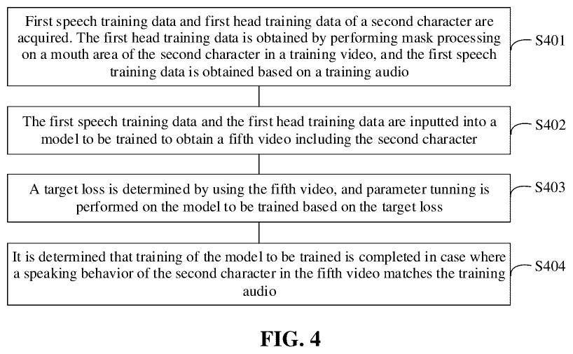

The embodiments of the present disclosure provide a method for model training, which may be performed by a processor of a computer device. FIG. 4 is a schematic flowchart of an implementation of a method for model training according to an embodiment of the present disclosure. As shown in FIG. 4, the method may include the following steps S401 to S404.

At step S401, first speech training data and first head training data of a second character are acquired. The first head training data is obtained by performing mask processing on a mouth area of the second character in a training video, and the first speech training data is obtained based on a training audio.

Here, the training audio and the training video are predetermined audio samples and video samples for model training, respectively. At least one video frame including the second character may be included in the training video. Any suitable speech content may be included in the training audio. In implementation, those skilled in the art may adopt any appropriate training audio and training video according to the actual situation, which is not limited in the embodiments of the present disclosure. For example, the training audio and the training video may be collected in advance in a real scene, or may be synthesized according to a set text, context, or the like.

The first speech training data may be obtained based on the training audio. In some implementations, the first speech training data may include the training audio. In some embodiments, the first speech training data may include a second speech feature extracted from the training audio.

The first head training data may be obtained by performing mask processing on the mouth area of the second character in the training video. In some embodiments, the first head training data may include a sixth video obtained by performing mask processing on the mouth area of the second character in the training video. In some embodiments, the first head training data may include a second head feature extracted from the sixth video. In implementation, mask processing is performed on the mouth area of the second character in the training video with reference to the manner of performing mask processing on the mouth area of the first character in the first video in the foregoing embodiment, to obtain a sixth video.

At step S402, the first speech training data and the first head training data are inputted into a model to be trained to obtain a fifth video including the second character.

At step S403, a target loss is determined by using the fifth video, and parameter tunning is performed on the model to be trained based on the target loss.

At step S404, it is determined that training of the model to be trained is completed in case where a speaking behavior of the second character in the fifth video matches the training audio.

Here, the target loss may characterize how well the speaking behavior of the second character in the fifth video matches the training audio. In implementation, those skilled in the art may determine the target loss based on the fifth video in a suitable manner according to the actual situation, which is not limited in the embodiments of the present disclosure. For example, the first loss may be determined based on the fifth video and the reference video corresponding to the training audio. Here, the reference video may be a preset video tag corresponding to the training audio. The speaking behavior of the second character in the reference video matches the training audio.

In case where the target loss characterizes that the speaking behavior of the second character in the fifth video matches the training audio, the parameter tunning of the model to be trained may be not required, that is, it is determined that the training of the model to be trained is completed. In case where the target loss characterizes that the speaking behavior of the second character in the fifth video does not match the training audio, the parameter tunning may be performed on the model to be trained, that is, it is determined that the training of the model to be trained is not completed.

In some embodiments, it may be determined that the speaking behavior of the second character in the fifth video does not match the training audio in case where the target loss does not satisfy a first preset condition, and it may be determined that the speaking behavior of the second character in the fifth video matches the training audio in case where the target loss satisfies the first preset condition or the number of performing parameter tunning on the model to be trained reaches a set threshold. The first preset condition may include, but is not limited to, at least one of a condition that the target loss is less than a set loss threshold, the change of the target loss converges, and the like. In implementation, the first preset condition may be set according to the actual situation, which is not limited in the embodiments of the present disclosure.

The manner of performing parameter tunning on the model to be trained based on the target loss may be determined according to the actual situation, which may include, but is not limited to, at least one of a gradient descent method, a Newton momentum method, and the like.

In the embodiment of the present disclosure, in the process of training the model to be trained, on the one hand, since the first head training data is obtained by performing mask processing on the mouth area of the second character in the training video, the first head training data is not affected by the mouth area and thus is reasonable and accurate, and the first speech training data is obtained based on the training audio and thus can well reflect the speech characteristics in the training audio. On the other hand, since the target loss is determined based on the fifth video, and it is determined that the training of the model to be trained is completed in case where the speaking behavior of the second character in the fifth video matches the training audio. Therefore, parameter tunning of the model to be trained based on the target loss can improve the ability of generating the fifth video by the model to be trained based on the first head training data and the first speech training data. In this way, in the video generated by the trained model to be trained, the appearance and posture of the head of the character are accurate, and the appearance and posture of the head can be matched with the driving audio, so that the overall speaking behavior of the character can be reasonable and realistic, thereby improving the quality of the generated video.

In some embodiments, the model to be trained includes a rendering generation network, the first speech training data includes a second speech feature, and the first head training data includes a second head feature. The above step S402 may include the following step S411.

At step S411, the rendering generation network is used to generate a fifth video including the second character based on the second head feature and the second speech feature.

Here, the rendering generation network may be used to generate the fifth video based on the second head feature and the second speech feature with reference to the manner of generating the second video based on the first head feature and the first speech feature in the foregoing embodiment. The rendering generation network may include, but is not limited to, an encoder-decoder network, a decoder network, or a generative adversarial network, etc.

In some embodiments, the model to be trained includes a rendering generation network and at least one of a first feature extraction network and a second feature extraction network.

In case where the model to be trained includes the first feature extraction network rather than a second feature extraction network, the first head training data includes a sixth video obtained by performing mask processing on the mouth area of the second character in the training video, and the first speech training data includes a second speech feature. The above step S402 may include the following steps S421a to S421b.

At step S421a, the first feature extraction network is used to extract the second head feature of the second character from the sixth video.

At step S421b, the rendering generation network is used to generate a fifth video including the second character based on the second head feature and the second speech feature.

Here, the first feature extraction network may be used to extract the second head feature of the second character from the sixth video with reference to the manner of extracting the first head feature of the first character from the third video in the foregoing embodiment. The first feature extraction network may include, but is not limited to, at least one of a CNN, an RNN, a Transformer encoder, and the like. For example, the first feature extraction network may employ a VGG network (such as VGG 16, VGG 19, etc.) as a base network.

In case where the model to be trained includes the second feature extraction network rather than the first feature extraction network, the first head training data includes second head features, and the first speech training data includes training audio. The above step S402 may include the following steps S422a to S422b.

At step S422a, the second feature extraction network is used to perform feature extraction on the training audio to obtain a second speech feature.

At step S422b, the rendering generation network is used to generate a fifth video including the second character based on the second head feature and the second speech feature.

Here, the second feature extraction network may be used to perform feature extraction on the training audio with reference to the manner of performing feature extraction on the first audio in the foregoing embodiment to obtain the second speech feature. The second feature extraction network may include, but is not limited to, at least one of a CNN, an RNN, a Transformer encoder, and the like.

In case where the model to be trained includes the first feature extraction network and the second feature extraction network, the first head training data includes the sixth video, and the first speech training data includes the training audio. The above step S402 may include the following steps S423a to S423c.

At step S423a, the first feature extraction network is used to extract the second head feature of the second character from the sixth video.

At step S423b, the second feature extraction network is used to perform feature extraction on the training audio to obtain a second speech feature.

At step S423c, the rendering generation network is used to generate a fifth video including the second character based on the second head feature and the second speech feature.

Both the first feature extraction network and the second feature extraction network may be pre-trained or may be untrained, which are not limited herein. The parameter tunning may be performed on network parameters of all networks in the model to be trained, or only on network parameters of the rendering generation network, or on network parameters of the rendering generation network and network parameters of one of the first feature extraction network and the second feature extraction network.

In some embodiments, the model to be trained includes the rendering generation network and the first feature extraction network. The above step 403 of performing parameter tunning on the model to be trained based on the target loss includes the following step S431.

At step S431, parameter tunning is performed on the rendering generation network and the first feature extraction network based on the target loss.

In this way, since the training data required for training the first feature extraction network is usually not too much, parameter tunning may be performed on the first feature extraction network and the rendering generation network together to improve the efficiency of model training and the ability of the trained model for generating a video.

In some embodiments, in case where the model to be trained includes the second feature extraction network, the second feature extraction network may be pre-trained to obtain the trained second feature extraction network. In this way, since the training data required for training the second feature extraction network is usually large, the second feature extraction network is trained separately in advance, the second feature extraction network can good learn the ability of characterizing speech features, thereby improving the training efficiency of the second feature extraction network, and improving the overall efficiency and effect of model training.

In some embodiments, the first feature extraction network includes a first encoder and a mapping sub-network, and the second head feature includes a second non-mouth area feature and a second head movement feature. The above operation that the first feature extraction network is used to extract the second head feature of the second character from the sixth video may include the following steps S441 to S442.

At step S441, the first encoder is used to perform encoding processing on the sixth video to obtain the second non-mouth area feature.

At step S442, the mapping sub-network is used to map the second non-mouth area feature to a preset movement feature space to obtain the second head movement feature.

Here, steps S411 to S412 correspond to steps S111 to S112 in the foregoing embodiment, respectively, and in implementation of steps S411 to S412, reference may be made to the embodiments of steps S111 to S112.

In the above embodiment, the first encoder and the mapping sub-network are used to model visual features of the non-mouth area of the second character and the head action of the second character, respectively. Therefore, the network structure of the first encoder and the mapping sub-network can be simplified, and the second non-mouth area features extracted by the trained first encoder can characterize the visual features of the non-mouth area of the second character, and the second head action features extracted by the trained mapping sub-network can characterize the head movement of the second character, thereby further improving the rationality and reality of the overall speaking behavior of the second character in the fifth video generated by the trained model and improving quality of the fifth video.

In some embodiments, the operation that the rendering generation network is used to generate a fifth video including the second character based on the second head feature and the second speech feature may include the following steps S451 to S452.

At step S451, the second head feature and the second speech feature are fused to obtain a second fusion feature.

Here, referring to the method of fusing the first head feature and the first speech feature in the foregoing embodiment, the second head feature and the second speech feature may be fused to obtain the second fusion feature.

At step S452, the rendering generation network is used to generate the fifth video based on the second fusion feature.

Here, the rendering generation network may be used to generate the fifth video based on the second fusion feature with reference to the manner of generating the second video based on the first fusion feature in the foregoing embodiment.

In the embodiment of the present disclosure, the second head feature and the second speech feature are fused to obtain the second fusion feature. Then, the rendering generation network is used to generate an accurate fifth video based on the second fusion feature, so that the speaking behavior of the second character in the fifth video may be better matched with the second audio.

In some embodiments, the model to be trained includes the rendering generation network and the second feature extraction network, the second feature extraction network includes a second encoder and a third encoder, and the second speech feature includes a second content feature and a second emotion feature.

The operation that the second feature extraction network is used to perform feature extraction on the training audio to obtain a second speech feature may include the following steps S461 to S462.

At step S461, the second encoder is used to perform encoding processing on the training audio to obtain the second content feature.

At step S462, the third encoder is used to perform encoding processing on the training audio to obtain the second emotion feature.

Here, the second encoder and the third encoder in the second feature extraction network may be used to perform encoding processing on the training audio, respectively, to obtain a second content feature characterizing the speech content and a second emotion feature characterizing the emotion included in the speech.

In implementation, the second encoder and the third encoder may be pre-trained in any suitable manner.

In some embodiments, the cross-reconstruction decoupling network may be used to train the second encoder and the third encoder to obtain the trained second encoder and the trained third encoder.

The above step S451 may include the following step S463.

At step S463, the second header feature and the second content feature are fused to obtain a second fusion feature.

Here, the second header feature and the second content feature may be fused with reference to the manner of fusing the first header feature and the first content feature in the foregoing embodiment to obtain the second fusion feature.

The above step S452 may include the following step S464.

At step S464, the rendering generation network is used to generate the fifth video based on the second fusion feature and the second emotion feature.

Here, the rendering generation network may be used to generate a fifth video based on the second fusion feature and the second emotion feature with reference to the manner of generating the second video in the foregoing embodiment.

In the above embodiment, the second content feature and the second emotion feature are extracted from the training audio by using the second encoder and the third encoder, respectively. The second head feature and the second content feature are fused to obtain a second fusion feature, and a fifth video is generated based on the second fusion feature and the second emotion feature. In this way, the content feature and the emotion feature in the training audio may be decoupled, so that when the second content feature drives the generation of the mouth movement, the facial expression of the second character may be adaptively adjusted in combination with the second emotion feature, and the appearance and posture of head of the second character in the generated fifth video may be matched with the speech content and emotion in the training audio. In this way, the rationality and reality of the overall speaking behavior of the second character in the fifth video generated by the trained model may be further improved, and the quality of the generated fifth video may be improved.

In some embodiments, the rendering generation network includes a fourth encoder and a first decoder. The above step S464 may include the following steps S471 to S472.

At step S471, the fourth encoder is used to perform encoding processing on the second fusion feature to obtain an encoded second fusion feature.

At step S472, the first decoder is used to perform decoding processing on the second emotion feature and the encoded second fusion feature to obtain the fifth video.

In implementation, steps S471 to S472 correspond to steps S221 to S222 in the foregoing embodiments, respectively, the embodiments of steps S221 to S222 may be referred to.

In some implementations, the rendering generation network may employ a U-shaped network (Unet), the fourth encoder may be an encoder in the Unet network, and the first decoder may be a decoder in the Unet network. The input of each decoder in the Unet network may include a second emotion feature, an encoded second fusion feature, and a feature outputted by the encoder in the Unet network corresponding to the decoder.

In some embodiments, the model further includes a face detection network. The method further includes the following steps S481 to S482.

At step S481, the face detection network is used to detect a face of the second character in the training video to obtain face key points corresponding to at least one second video frame in the training video, and determine, for each second frame, a mouth area corresponding to the second video frame based on the face key points corresponding to the second video frame.

Here, the face detection network may be pre-trained in a suitable manner according to the actual situation.

In implementation, the face detection network may be used to detect the face in the training video and determine the mouth area corresponding to at least one second video frame in the training video with reference to the manner of detecting the face of the first character in the first video and determining the mouth area corresponding to at least one first video frame in the first video in the foregoing embodiment.

At step S482, mask processing is performed on the respective mouth area corresponding to each second video frame to obtain the sixth video.

Here, the masking process may be performed on the respective mouth area corresponding to each second video frame with reference to the manner of performing the masking process on the respective mouth area corresponding to each first video frame in the foregoing embodiment.

In the above embodiment, the face detection network is used to detect the face of the second character in the training video to obtain face key points corresponding to at least one second video frame in the training video. For each second video frame, a mouth area corresponding to the second video frame is determined based on face key points corresponding to the second video frame. Mask processing is performed on the respective mouth area corresponding to each second video frame to obtain the sixth video. In this way, the mask processing can be performed on the mouth area of the second character in the training video quickly and accurately to obtain the sixth video.

In some embodiments, the model further comprises a third feature extraction network. The method further includes the following steps S491 to S492.

At step S491, a second reference video frame is determined from the training video.

At step S492, the third feature extraction network is used to extract a second identity feature of the second character from the second reference video frame.

Here, the third feature extraction network may be determined by those skilled in the art according to the actual situation, which is not limited in the embodiments of the present disclosure. In implementation, the third feature extraction network may include, but is not limited to, at least one of a CNN, an RNN, a Transformer encoder, and the like. For example, the third feature extraction network may employ a VGG network (such as VGG16, VGG19, etc.) as a base network.

The operation that the rendering generation network is used to generate a fifth video including the second character based on the second head feature and the second speech feature may include the following step S493.

At step S493, the rendering generation network is used to generate a fifth video including the second character based on the second head feature, the second identity feature, and the second speech feature.

Here, step S491 and step S493 correspond to step S311 and step S312 in the foregoing embodiment, respectively, and in implementation, reference may be made to the embodiments of the foregoing step S311 and step S312.

In some embodiments, the step S403 that the parameter tunning is performed on the model to be trained based on the target loss may include: performing parameter tunning on network parameters of the first feature extraction network, network parameters of the third feature extraction network and network parameters of the rendering generation network based on the target loss.

Here, the manner of parameter tunning on the network parameters of the third feature extraction network may be determined according to the actual situation, and may include, but is not limited to, at least one of a gradient descent method, a Newton momentum method, and the like, which is not limited in the embodiment of the present disclosure.

In the above embodiment, the second reference video frame is determined from the training video, and the second identity feature of the second character is extracted from the second reference video frame. A fifth video including a second character is generated based on the second head feature, the second identity feature, and the second speech feature. In this way, the second identity features of the second character are comprehensively considered in the process of generating the fifth video, so that the overall visual features of the second character in the fifth video and the identity consistency of the second character in respective video frame may be maintained, and the trained model may be applied in the scenes of generating speech videos of different characters.

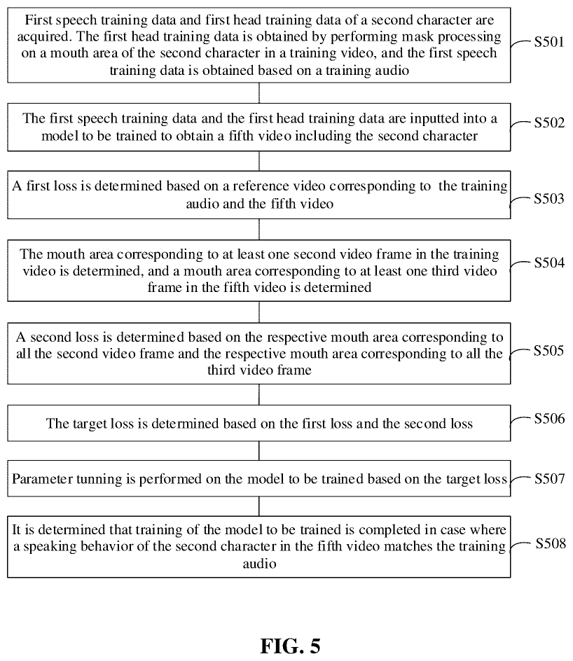

The embodiments of the present disclosure provide a method for model training, which may be performed by a processor of a computer device. FIG. 5 is a schematic flowchart of an implementation of a method for model training according to an embodiment of the present disclosure. As shown in FIG. 5, the method may include the following steps S501 to S508.

At step S501, first speech training data and first head training data of a second character are acquired. The first head training data is obtained by performing mask processing on a mouth area of the second character in a training video, and the first speech training data is obtained based on a training audio.

At step S502, the first speech training data and the first head training data are inputted into a model to be trained to obtain a fifth video including the second character.

Here, the steps S501 to S502 described above correspond to steps S401 to S402 in the embodiments described above, respectively, and in implementation, reference may be made to the embodiments described above of steps S401 to S402.

At step S503, a first loss is determined based on the fifth video and a reference video corresponding to the training audio.

Here, the reference video may be a preset video tag corresponding to the training audio. The speaking behavior of the second character in the reference video matches the training audio.

The first loss characterizes a loss between the fifth video and the reference video. In implementation, any suitable loss function may be used to determine the first loss, which is not limited in the embodiments of the present disclosure.

It is to be understood that the loss functions employed in step S503 and other steps below may include, but are not limited to, at least one of an absolute value loss function, a least square error loss function, a cosine loss function, a cross-entropy loss function, and the like.

In some embodiments, the first loss L_{recon} may be determined by L1 reconstruction loss function as shown in formula 1-1 below.

$${L}_{recon} = \frac{1}{K} {\sum }_{i = 1}^{K} {‖ {L}_{gi} - {L}_{ri} ‖}_{1} \qquad ( 1 - 1 )$$

L_{gi} denotes the i-th third video frame in the generated fifth video, Lᵣᵢ denotes the i-th fourth video frame in the reference video, and K denotes the total number of video frames in the fifth video or the reference video.

At step S504, the mouth area corresponding to at least one second video frame in the training video is determined, and a mouth area corresponding to at least one third video frame in the fifth video is determined.

Here, the mouth area corresponding to at least one second video frame in the training video and the mouth area corresponding to at least one third video frame in the fifth video may be determined with reference to the manner of detecting the face in the first video and determining the mouth area corresponding to the at least one first video frame in the first video in steps S301 to S302 in the foregoing embodiment.

At step S505, a second loss is determined based on the respective mouth area corresponding to all the second video frame and the respective mouth area corresponding to all the third video frame.

Here, the second loss characterizes a loss between the respective mouth area corresponding to all the third video frame and the respective mouth area corresponding to all the second video frame. In implementation, any suitable loss function may be employed to determine the second loss, which is not limited in the embodiments of the present disclosure.

In some embodiments, the second loss L_{m-recon} may be determined by L1 reconstruction loss function as shown in formula 1-2 below.

$${L}_{m - recon} = \frac{1}{K} {\sum }_{i = 1}^{K} {‖ {M}_{gi} - {M}_{ri} ‖}_{1} \qquad ( 1 - 2 )$$

M_{gi} denotes a mouth area in the i-th third video frame in the generated fifth video, Mᵣᵢ denotes a mouth area in the i-th second video frame in the training video.

At step S506, the target loss is determined based on the first loss and the second loss.

It can be understood that the target loss may be in direct proportion to each of the first loss and the second loss. In this way, the first loss between the fifth video generated by the trained model and the reference video and the second loss between the mouth area corresponding to each third video frame in the fifth video and the mouth area corresponding to each second video frame in the training video may be minimized, thereby improving the overall consistency between the fifth video generated by the model and the reference video and the consistency between the fifth video and the mouth area in the training video.

In some embodiments, the sum of the first loss and the second loss may be determined as the target loss.

In some embodiments, different weights may be set for the first loss and the second loss, respectively, and the first loss and the second loss may be weighted and summed to obtain the target loss.

At step S507, parameter tunning is performed on the model to be trained based on the target loss.

At step S508, it is determined that training of the model to be trained is completed in case where a speaking behavior of the second character in the fifth video matches the training audio.

Here, the steps S507 to S508 described above correspond to steps S403 to S404 in the embodiments described above, respectively, and in implementation of the steps S507 to S508, reference may be made to the embodiments described above of steps S403 to S404.

In the embodiment of the present disclosure, in the process of determining the target loss, the loss between the fifth video and the reference video corresponding to the training audio and the loss between the respective mouth area corresponding to each third video frame in the fifth video and the respective mouth area corresponding to each second video frame in the training video are comprehensively considered. Therefore, the overall consistency between the fifth video generated by the model and the reference video and the consistency of the mouth area in the fifth video and the mouth area in the training video are restricted during the training process, thereby improving the synchronization between the mouth action of the second character in the fifth video generated by the trained model and the training audio, that is, improving the lip synchronization of the character's speech in the video generated by the trained model.

In some embodiments, the above method may further include steps S511 to S513 as follows.

At step S511, a video segment and an audio segment which are matched with each other are extracted from the fifth video and the training audio, respectively.

At step S512, encoding processing is performed on the video segment and the audio segment to obtain a first encoding feature and a second encoding feature.

Here, the video segment and the audio segment matched with each other refer to the video segment and the audio segment corresponding to the same time interval. For example, a video segment may be determined from the fifth video first, and then an audio segment corresponding to the time interval may be determined from the training audio according to the time interval corresponding to the video segment, thereby obtaining a pair of video segment and audio segment matched with each other.

In some embodiments, a pre-trained feature alignment network (such as a SyncNet network) may be used to extract a video segment and an audio segment which are matched with each other from the fifth video and the training audio, respectively, and perform encoding processing on the extracted video segment and the extracted audio segment, respectively, to obtain the first encoding feature and the second encoding feature. In implementation, the feature alignment network may include a video encoder and an audio encoder built based on a VGG network. The video encoder may be used to perform encoding processing on the video segment to obtain the first encoding feature. The audio encoder may be used to perform encoding processing on the audio segment corresponding to the time interval in which the video segment is located to obtain the second encoding feature.

At step S513, a third loss is obtained based on the first encoding feature and the second encoding feature.

Here, the third loss characterizes a loss between the first encoding feature and the second encoding feature. In implementation, any suitable loss function may be used to determine the third loss, which is not limited in the embodiments of the present disclosure.

In some embodiments, a similarity between the first encoding feature and the second encoding feature is determined, and a third loss between the first encoding feature and the second encoding feature is determined based on the similarity.

For example, the similarity P_{sync} between the first encoding feature and the second encoding feature may be determined in the manner as shown in the following formula 1-3.

$${P}_{sync} = \frac{1}{max ( {‖ v ‖}_{2} \cdot {‖ s ‖}_{2} , ε )} \qquad ( 1 - 3 )$$

v and s denote the first encoding feature and the second encoding feature respectively, the similarity P_{sync} denotes a value from 0 to 1, ε denotes an extremely small value that prevents the denominator in the formula from being valued 0, for example, ε may be used as 10⁻⁶.

Based on the similarity P_{sync} between the first encoding feature and the second encoding feature, the third loss E_{sync} between the first encoding feature and the second encoding feature may be determined in the manner as shown in formula 1-4 below.

$${E}_{sync} = \frac{1}{K} {\sum }_{i = 1}^{K} - log ( {P}_{sync}^{i} ) \qquad ( 1 - 4 )$$

$${P}_{sync}^{i}$$

denotes the similarity between the first encoding sub-feature corresponds to the i-th video frame in the first encoding feature and the second encoding sub-feature corresponding to the i-th audio frame in the second encoding feature.

The above step S506 may include the following step S514.

At step S514, the target loss is determined based on the first loss, the second loss, and the third loss.

It can be understood that the target loss and the third loss may be in a direct proportional relationship. In this way, the third loss between the fifth video generated by the trained model and the training audio may be minimized, thereby improving the lip synchronization of the character's speech in the video generated by the trained model.

In some embodiments, the sum of the first loss, the second loss, and the third loss may be determined as the target loss.

In some embodiments, different weights may be set for the first loss, the second loss, and the third loss, respectively, and the first loss, the second loss, and the third loss may be weighted and summed to obtain the target loss.

In the above embodiment, in the process of determining the target loss, the first loss between the fifth video and the reference video corresponding to the training audio, the second loss between the respective mouth area corresponding to each third video frame in the fifth video and the respective mouth area corresponding to each second video frame in the training video, and the third loss characterizing the synchronization between the audio segment in the training audio and the video segment in the fifth video are comprehensively considered. Therefore, the overall consistency between the fifth video generated by the model and the reference video, the consistency of the mouth area between the fifth video and the training audio are restricted during the training process, thereby further improving the lip synchronization between the fifth video and the training audio, and further improving the lip synchronization of the character's speech in the video generated by the trained model.

In some embodiments, the method further includes steps S521 to S522 as follows.

At step S521, a reality degree of at least one fourth video frame in the reference video and a reality degree of at least one third video frame in the fifth video are determined by using the first discriminator.

Here, the first discriminator may be pre-trained, or may be updated and trained in the process of training the first feature extraction network and the rendering generation network, which is not limited in the embodiments of the present disclosure.

The overall quality of the fourth video frame and the third video frame may be discriminated by the first discriminator to determine the reality degree of the corresponding video frame.

At step S522, a fourth loss is determined based on the respective reality degree of all the fourth video frame and the respective reality degree of all the third video frame.

Here, the fourth loss characterizes the reality degree of each fourth video frame in the reference video and the reality degree of each third video frame in the fifth video. In implementation, any suitable loss function may be used to determine the fourth loss, which is not limited in the embodiments of the present disclosure.

In some embodiments, the fourth loss L_{disc} may be determined in the manner as shown in formula 1-5 below.

L_{disc}=Eₓ_{₁}_{~L}_{ᵣ}[log(D₁(x₁))]+Eₓ_{₂}_{~L}_{_{g}}[log(D₁(x₂))] (1-5)

L_{g} denotes a set of video frames comprising all the third video frame in the generated fifth video, Lᵣ denotes a set of video frames comprising all the fourth video frame in the reference video, x₂ denotes a fourth video frame in the reference video, x₂ denotes a third video frame in the fifth video, D₁(−) denotes a first discriminator, D₁(x₁) denotes the reality degree of the fourth video frame x₁, D₁(x₂) denotes the reality degree of the third video frame x₂, and E[−] denotes a mean function.

The above step S514 may include the following step S523.

At step S523, the target loss is determined based on the first loss, the second loss, the third loss, and the fourth loss.

It can be understood that the target loss and the fourth loss may be in an inversely proportional relationship. In this way, the fourth loss corresponding to the fifth video generated by the trained model may be maximized, that is, the reality degree of each fourth video frame in the reference video and the reality degree of each third video frame in the fifth video may be maximized, thereby improving the overall quality of each video frame in the video generated by the trained model.

In some embodiments, the target loss may be obtained by subtracting the fourth loss from the sum of the first loss, the second loss and the third loss.

In some embodiments, different weights may be set for the first loss, the second loss, the third loss and the fourth loss, respectively, and the first loss, the second loss, the third loss and the fourth loss may be weighted and summed to obtain the target loss. In implementation, the weights corresponding to the first loss, the second loss and the third loss may be positive respectively, and the weight of the fourth loss may be negative.

In the above embodiment, the fourth loss representing the reality degree of each fourth video frame in the reference video and the reality degree of each third video frame in the fifth video is considered in the process of determining the target loss. Therefore, the overall quality of each video frame in the video generated by the model may be constrained in the training process, and the overall quality of the video generated by the trained model may be further improved.

In some embodiments, the method further includes steps S531 to S533 as follows.

At step S531, a second discriminator is used to determine, for each pair of adjacent fourth video frames in the reference video, a true adjacency degree between the adjacent fourth video frames of the pair.

At step S532, the second discriminator is used to determine, for each pair of adjacent third video frames in the fifth video, a true adjacency degree between the adjacent third video frames of the pair.

Here, the second discriminator may be pre-trained, or may be updated and trained in the process of training the first feature extraction network and the rendering generation network, which is not limited in the embodiments of the present disclosure.

The true adjacency degree between adjacent video frames of the pair may characterize the degree to which the video frames of the pair are adjacent. The second discriminator may be used to determine the degree to which two adjacent video frames are adjacent, to obtain the true adjacency degree between the two video frames.

At step S533, a fifth loss is determined based on the true adjacency degrees between adjacent fourth video frames of all pairs and the true adjacency degrees between adjacent third video frames of all pairs.

Here, the fifth loss characterizes the degree of adjacency of each pair of adjacent fourth video frames in the reference video and the degree of adjacency of each pair of adjacent third video frames in the fifth video. In implementation, any suitable loss function may be employed to determine the fifth loss, which is not limited in the embodiments of the present disclosure.

In some embodiments, the fifth loss L_{disc_c} may be determined in the manner as shown in formula 1-6 below.

L_{disc_c}=Eₓ_{_{c1}}_{~L}_{_{rc}}[log(D₂(x_{c1}))]+Eₓ_{_{c2}}_{~L}_{_{gc}}[log(D₂(x_{c2}))] (1-6)

L_{gc} denotes a set of video frame pairs comprising all pairs of adjacent third video frames in the generated fifth video, L_{rc} denotes a set of video frame pairs comprising all pairs of fourth video frames in the reference video, x_{c1} denotes a pair of fourth video frames in the reference video, x_{c2} denotes a pair of third video frames in the fifth video, D₂(−) denotes a second discriminator, D₂(x_{c1}) denotes a true adjacency degree of a pair of fourth video frames x_{c1}, D₂(x_{c2}) denotes a true adjacency degree of a pair of third video frames x_{c2}, E[−] denotes a mean function.

The above step S523 may include the following step S534.

At step S534, the target loss is determined based on the first loss, the second loss, the third loss, the fourth loss and the fifth loss.

It can be understood that the target loss and the fifth loss may be in an inversely proportional relationship. Therefore, the fifth loss corresponding to the fifth video generated by the trained model may be maximized, that is, the true adjacency degree between each adjacent fourth video frames in the reference video and the true adjacency degree between each adjacent third video frames in the fifth video may be maximized, thereby improving the inter-frame consistency between the video frames in the video generated by the trained model.

In some embodiments, the target loss may be obtained by subtracting the fourth loss and the fifth loss from the sum of the first loss, the second loss and the third loss.

In some embodiments, different weights may be set for the first loss, the second loss, the third loss, the fourth loss and the fifth loss, respectively, and the first loss, the second loss, the third loss, the fourth loss, and the fifth loss may be weighted and summed to obtain the target loss. In implementation, the weights corresponding to the first loss, the second loss and the third loss may be positive respectively, and the weights of the fourth loss and the fifth loss may be negative.

For example, the target loss Lₜₒₜₐₗ may be obtained by weighting and summing the first loss L_{recon}, the second loss L_{m-recon}, the third loss E_{sync}, the fourth loss L_{disc} and the fifth loss L_{disc_c} in the manner as shown in the following formula 1-7.

Lₜₒₜₐₗ=λ₁*L_{recon}+λ₂*L_{m-recon}+λ₃*E_{sync}+λ₄*L_{disc}+λ₅*L_{disc_c} (1-7)

λ₁, λ₂, λ₃, λ₄ and λ₅ denote the weights of the first loss L_{recon}, the second loss L_{m-recon}, the third loss E_{sync}, the fourth loss L_{disc} and the fifth loss L_{disc_c}, respectively, λ₁, λ₂ and λ₃ each is greater than 0, λ₄ and λ₅ each is less than 0.

In the above embodiment, in the process of determining the target loss, the fifth loss representing the true adjacency degree between adjacent fourth video frames of each pair in the reference video and the true adjacency degree between adjacent third video frames of each pair in the fifth video is considered. Therefore, the inter-frame consistency between the video frames in the video generated by the model may be constrained in the training process, which facilitates a good temporal stability of the video generated by the trained model, reduces the inter-frame fluctuation, thereby further improving the overall quality of the video generated by the trained model.

It should be noted that, in some embodiments, those skilled in the art may determine the target loss based on at least one of the first loss, the second loss, the third loss, the fourth loss and the fifth loss according to an actual application scenario, which is not limited in the embodiments of the present disclosure.

Hereinafter, the applications of the method for video generation and the method for model training provided by the embodiment of the present disclosure in an actual scenario are described below, and the speech-driven speaker synthesis task is described as an example.

Given one or several target face images or target character videos and a speech data source (such as a preset first audio) used as a driving speech, the speech-driven speaker synthesis task drives the face movement (including lips, expressions, etc.) of the target character through the speech data source to obtain a realistic speaking video of the target character. This speech-driven speaker synthesis task has a wide range of application scenarios, such as video dubbing in different languages, remote presentation in video conferences, character generation in video games, video transmission with limited bandwidth, assistive devices for enhancing speech understanding while protecting privacy or for the hearing impaired, etc. Also, the speech-driven speaker synthesis task may also promote the development of anti-attack in the security field by providing a large amount of training simulation data. Another potential application scenario is the field of digital humans. Offline-online-presence is an important path for the development of digital humans. From identity-oriented digital humans who focus on animation and rendering, to service-oriented digital humans that integrate language comprehension, expression, learning and interaction capabilities, from online services to on-site experiences, digital humans will enter a period of large-scale application, which will accelerate the transformation into real productivity and create greater value for both the consumer market and enterprise services. The speech-driven two-dimensional digital human may play an important role in expression and interaction.

In the process of implementing the present disclosure, the inventors have found that there are at least the following problems in the solution of speech-driven speaker video generation and the solution of model training in the related art.

1) The modeling of the appearance and posture of the non-mouth area of the character is not considered, and the head movement and facial expression that conform with the speech content are ignored, that is, the modeling of the appearance and posture of the character's head except the mouth area is ignored, which results in that the head movement and expression of the target character in the generated video is unreasonable and unrealistic. The appearance and posture of the head of the target character (corresponding to the aforementioned first character or second character) is very complex, including but being not limited to internal subject characteristics, external camera position, head movement and facial expression, etc. This complexity originates not only from the modeling of face areas, but also from the modeling of head movement and background.

2) The visual information is not utilized sufficiently. The process of processing visual information in the reference video (corresponding to the aforementioned first video or fifth video) is limited to multi-scale visual representation, but the high-level abstract representation is not fully decoupled and used, for example, the posture and movement information of the character and the identity information of the character are not fully considered.

3) The output of the video generation model used is usually a sequence of video frames, and there is no explicit inter-frame consistency constraint during the process of model training, which easily results in subtle artifacts in the generated video and subtle changes of the target character in the generated video, and cannot maintain the consistency of the identity of the target character.

In view of this, the embodiments of the present disclosure provide a method for video generation and a method for model training, which can improve the rationality and reality of the overall speaking behavior of a character in a generated video, thereby improving the quality of the generated video.

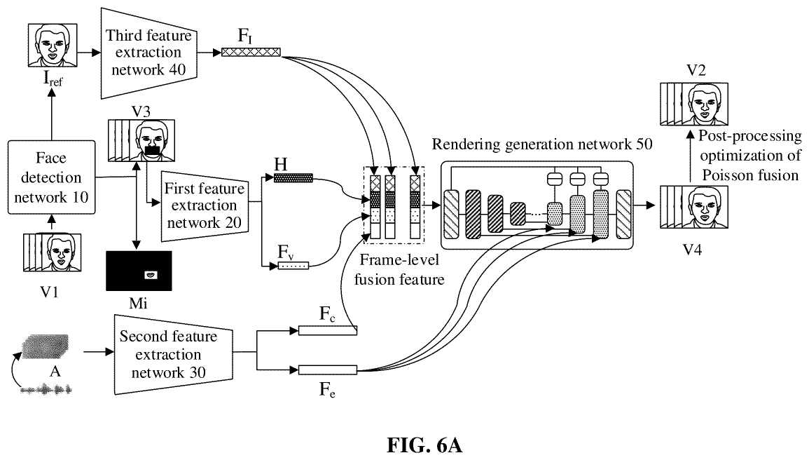

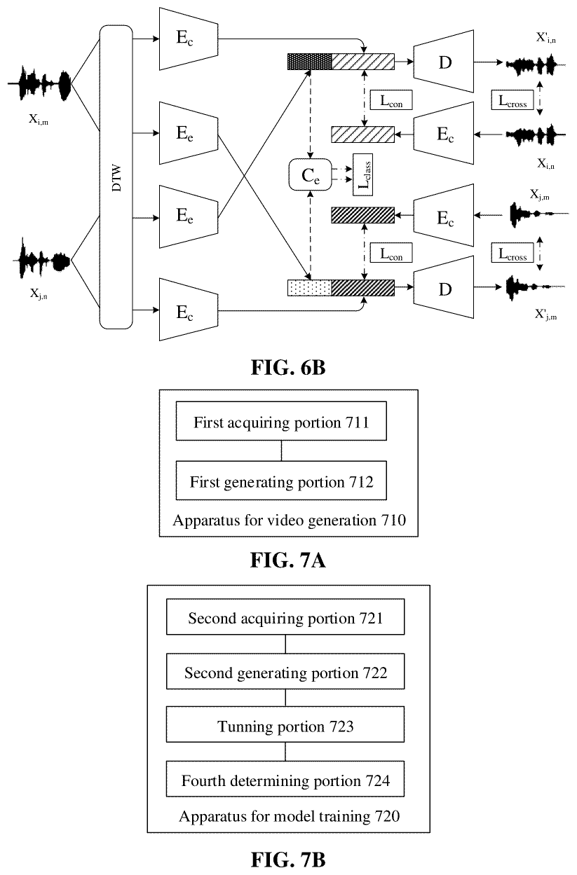

FIG. 6A is a schematic flowchart of an implementation of a method for video generation according to an embodiment of the present disclosure. As shown in FIG. 6A, the method for video generation may be implemented by a face detection network 10, a first feature extraction network 20, a second feature extraction network 30, a third feature extraction network 40 and a rendering generation network 50 in a pre-trained model. The rendering generation network 50 includes a fourth encoder and a first decoder. Hereinafter, the method for video generation according to an embodiment of the present disclosure is described with reference to FIG. 6A.

The method for video generation according to the embodiment of the present disclosure includes the following steps S601 to S609.

At step S601, a first audio A and a first video V1 including a first character are acquired.

At step S602, a pre-trained face detection network 10 is used to detect a face in the first video V1 to obtain face key points corresponding to at least one first video frame in the first video V1, and a mouth area Mi corresponding to each first video frame is determined based on the face key points corresponding to the first video frame, and a third video V3 composed of all the first video frame, in which mask processing is performed on a mouth area, is determined.

At step S603, a first reference video frame I_{ref} is determined from the first video V1.

For each first video frame in the first video V1, the first reference video frame I_{ref} may be determined from the first video V1 based on a distance between a first key point characterizing an upper lip and a second key point characterizing a lower lip corresponding to the first video frame. For example, the first video frame having the smallest distance between the first key point and the second key point may be determined as the first reference video frame I_{ref}.

At step S604, a first encoder in the first feature extraction network 20 is used to perform encoding processing on the third video V3 to obtain a first non-mouth area feature Fᵥ, and a mapping sub-network in the first feature extraction network 20 is used to map the first non-mouth area feature Fᵥ to a preset movement feature space to obtain a first head movement feature H.

At step S605, the second feature extraction network 30 is used to perform feature extraction on the first audio A to obtain a first content feature Fc and a first emotion feature Fe.

At step S606, the third feature extraction network 40 is used to extract a first identity feature FI of the first character from the first reference video frame I_{ref}.

At step S607, frame-level fusion is performed on the first non-mouth area feature Fᵥ, the first head movement feature H, the first identity feature FI and the first content feature Fc.

At step S608, the rendering generation network 50 is used to render and generate a fourth video V4 based on the frame-level fusion features and the first emotion features Fe.

The frame-level fusion features may be used as the input of the fourth encoder. The output of the fourth encoder, the first emotion feature Fe and a first visual feature Fo may be used as the input of the first decoder, and the output of the first decoder is the fourth video V4.

At step S609, Poisson fusion is performed on a face area and a background area in at least one fourth video frame in the fourth video V4 to obtain a second video V2. The speaking behavior of the first character in the second video V2 matches the first audio A.

It should be noted that the first feature extraction network 20 and the rendering generation network 50 in the above-described model may be trained by any one of the methods for model training in the embodiments described above. The target loss used in the model training is determined based on the first loss, the second loss, the third loss, the fourth loss and the fifth loss in the manner as shown in the above formula 1-7.

The face detection network 10 and the second feature extraction network 30 in the model described above may have been trained before training the first feature extraction network 20, the third feature extraction network 40 and the rendering generation network 50.

The process of training the second feature extraction network is described below.

The second feature extraction network includes a content encoder (corresponding to the aforementioned third encoder) for encoding speech content in audio and an emotion encoder (corresponding to the aforementioned fourth encoder) for encoding emotion components in audio. The trained content encoder and the trained emotion encoder are used to decouple and encode the speech content and the emotion information in the first audio, respectively, to obtain the decoupled content encoding (corresponding to the first content feature) and the emotion encoding (corresponding to the first emotion feature).

In order to realize audio-based face synthesis emotion control, extraction may be performed on two separate potential audio spaces to separately decouple an emotion component and a content component from audio. The two separate potential audio spaces include a time-independent space and a time-dependent space. The emotion component in the audio may be encoded based on the time-independent space to obtain emotion encoding with unknown content. The speech content of audio may be encoded based on the time-dependent space to obtain content encoding with unknown emotion. In implementation, aligned audio samples may be first constructed, and then a cross-reconstruction decoupling network is trained based on the aligned audio sample data, to obtain a content encoder and an emotion encoder respectively used for decoupling and encoding the speech content and the emotion information in the first audio.

In implementation, the cross-reconstruction decoupling network may be trained by using an audio dataset in which various characters speak the same corpus in different emotion states, to obtain the trained content encoder and the trained emotion encoder. The audio dataset may contain audio samples in which different characters speak the same speech content in different emotion states. Since speeches which have the same content but different emotions may have different speech speeds, a time alignment algorithm may be used to align speeches with uneven length in all the audio samples. In implementation, the Mel Frequency Cepstrum Coefficient (MFCC) may be used as audio representation, and the Dynamic Time Warping (DTW) algorithm may be used to warp the MFCC feature vector by stretching or contracting along the time dimension, to achieve time length alignment of the audio samples. For example, given two MFCC sequences S_{α} and S_{b} with the same content but different lengths, the DTW algorithm may calculate a set of index coordinate pairs {(i, j), . . . } by dynamic programming, and force S_{α}[i] and S_{b}[j] to be similar, the optimal match between the given sequences S_{α} and S_{b} aims at the following formula 2-1, that is, minimizing the sum of distance costs between the aligned MFCC features.

min Σ_{(i,j)∈P}d(S_{α}[i],S_{b}[i]) (2-1)

d denotes the distance loss, P denotes the alignment path, that is, calculating a set of index coordinate pairs by dynamic programming.

FIG. 6B is a schematic diagram of an implementation of training a content encoder and an emotion encoder using a cross-reconstruction decoupling network according to an embodiment of the present disclosure. As shown in FIG. 6B, the cross-reconstruction decoupling network may include a content encoder for modeling content information E_{c}, an emotion encoder for modeling emotion information Eₑ, a decoder D for decoding and reconstructing the content encoding and the emotion encoding into the audio, and a classifier Cₑ for classifying the emotion encoding. Given 4 aligned audio samples X_{i,m}={x_{i,m}}, X_{j,n}={x_{j,n}}, X_{j,m}={x_{j,m}} and X_{i,n}={x_{i,n}}, X_{i,m} has the content information i and emotion information m, X_{j,n} has content information j and emotion information n, X_{j,m} has content information j and emotion information m, X_{i,n} has content information i and emotion information n. First, the aligned audio samples X_{i,m} and X_{i,n} may be used as input of the cross-reconstructed decoupling network, the content encoder E_{c} and the emotion encoder Eₑ are used to decouple the content encoding E_{c} (x_{i,m}) and the emotion encoding Eₑ (x_{i,m}) in the audio sample X_{i,m}, and decouple the content encoding E_{c} (x_{j,n}) and the emotion encoding Eₑ (x_{j,n}) in the audio sample X_{j,n}, separately. Then, the decoder D may used to reconstruct an audio clip X′_{i,n}={x′_{i,n}} by using the content encoding E_{c}(x_{i,m}) of audio sample X_{i,m} and emotion encoding Eₑ (x_{j,n}) of audio sample X_{j,n}, and reconstruct an audio clip X′_{j,m}={x′_{j,m}} by using the content encoding E_{c} (x_{j,n}) of audio sample Xin and emotion encoding Eₑ (x_{i,m}) of audio sample X_{i,m}. Finally, the cross-reconstruction decoupling network may be supervised and trained based on the audio samples X_{i,n}={x_{i,n}} and X_{j,m}={x_{j,m}}. The loss for supervising and training the cross-reconstruction decoupling network may include a cross-reconstruction loss L_{cross}, a self-reconstruction loss L_{self}, a classification loss L_{class} and a content loss L_{con}.

For example, the cross-reconstruction loss L_{cross} may be determined in the manner as shown in formula 2-2 below.

$${L}_{cross} = {‖ D ( {E}_{c} ( {x}_{i , m} ) , {E}_{e} ( {x}_{j , n} ) ) - {x}_{i , n} ‖}_{2} + {‖ D ( {E}_{c} ( {x}_{j , n} ) , {E}_{e} ( {x}_{i , m} ) ) - {x}_{j , m} ‖}_{2} . \qquad ( 2 - 2 )$$

Furthermore, the self-reconstruction loss L_{self} may be determined in the manner as shown in formula 2-3 below.

$${L}_{self} = {‖ D ( {E}_{c} ( {x}_{i , m} ) , {E}_{e} ( {x}_{i , m} ) ) - {x}_{i , m} ‖}_{2} + {‖ D ( {E}_{c} ( {x}_{j , n} ) , {E}_{e} ( {x}_{j , n} ) ) - {x}_{j , n} ‖}_{2} \qquad ( 2 - 3 )$$

In order to drive the emotion encoder Eₑ to accurately classify to obtain the emotion category of each audio sample, and a classifier Cₑ may be used to construct the classification loss. The classification loss L_{class} may be determined in the manner as shown in formula 2-4 below.

$${L}_{class} = - {\sum }_{i = 1}^{N} ( {p}_{k} * log {q}_{k} ) \qquad ( 2 - 4 )$$

N represents the number of emotion categories, pk represents audio samples of the emotion category k, qₖ represents a category probability distribution of the audio sample predicted by the classifier Cₑ.

For audio content, samples of the same audio corpus should have similar audio content encoding, and the content loss is added to train the content encoder E_{c}. The content loss L_{con} may be determined in the manner as shown in formula 2-5 below:

$${L}_{con} = {\sum }_{k ∈ i , j} {‖ {E}_{c} ( {x}_{k , m} ) - {E}_{c} ( {x}_{k , n} ) ‖}_{2} \qquad ( 2 - 5 )$$

Combining the above four losses, the total training loss of the cross-reconstruction decoupling network may be determined according to the following formula 2-6.

L_{dis}=L_{cross}+L_{self}+λ_{cla}*E_{class}+λ_{con}*L_{con} (2-6)

λ_{cla} and λ_{con} denote the weights of the classification loss and the content loss, respectively.

In the embodiment of the present disclosure, on the one hand, the mouth area, the head movement and the non-mouth area of the character in the first video or the training video are respectively modeled, and visual information at different perception angles are used explicitly. Therefore, the degree of lip synchronization may be effectively improved, and reasonable head movement and expression may be generated. On the other hand, the posture movement information and identity information of the characters in the first video or training video are decoupled, the identity representation and posture movement of the specific character may be fully maintained, and the model may be trained in combination with inter-frame consistency constraints. Therefore, not only the unreasonable jitter of the characters in the generated video can be decreased, but also the identity representation of the specific character can be maintained. On the other hand, audio information can be decoupled and encoded to obtain the content encoding and the emotion encoding in the audio through the trained content encoder and the trained emotion encoder of the cross-reconstruction decoupling network, so that the mouth movement may be driven through the audio content, and the facial expression of the character may be adaptively adjusted in combination with emotion encoding. In another aspect, the generated fourth video is post-processed through Poisson fusion, which can transitionally connect the face area, the body and the background, thereby reducing the obvious artifact interval in the video frame. It can be seen that according to the embodiment of the present disclosure, a 2D digital human speech synthesis model having high lip synchronization rate and high fidelity of the target character can be obtained.

It will be understood by those skilled in the art that in the method described above of the detailed embodiment, the described order of each step does not mean a strict order of execution and constitutes any limitation on the implementation process, and the specific order of execution of the steps should be determined by their functions and possible internal logic.

Based on the foregoing embodiments, an embodiment of the present disclosure provides an apparatus for video generation, which includes various units and various portions part in each unit, and may be implemented by a processor in a computer device, and may, of course, by the specific logic circuits. In the process of implementation, the processor may be a Central Processing Unit (CPU), a Microprocessor Unit (MPU), a Digital Signal Processor (DSP), a Field Programmable Gate Array (FPGA), or the like.

FIG. 7A is a schematic structural diagram of a composition of an apparatus for video generation according to an embodiment of the present disclosure. As shown in FIG. 7A, the apparatus 710 for video generation includes a first acquiring portion 711 and a first generating portion 712.

The first acquiring portion 711 is configured to acquire a first speech feature and a first head feature of a first character. The first head feature is obtained by performing mask processing on a mouth area of the first character in a first video, and the first speech feature is obtained based on a first audio.

The first generating portion 712 is configured to generate a second video including the first character based on the first head feature and the first speech feature. A speaking behavior of the first character in the second video matches the first audio.

In some embodiments, the first head feature includes a first non-mouth area feature and a first head movement feature. The first non-mouth area feature is obtained by performing encoding processing on a third video, and the third video is obtained by performing mask processing on the mouth area of the first character in the first video. The first head movement feature is obtained by mapping the first non-mouth area feature to a preset movement feature space.

In some embodiments, the first acquiring portion is further configured to: fuse the first head feature and the first speech feature to obtain a first fusion feature, and generate the second video based on the first fusion feature.

In some embodiments, the first speech feature includes a first content feature and a first emotion feature. The first acquiring portion is further configured to: fuse the first header feature and the first content feature to obtain a first fusion feature; and generate the second video based on the first fusion feature and the first emotion feature.

In some embodiments, the first acquiring portion is further configured to: perform encoding processing on the first fusion feature to obtain an encoded first fusion feature; and perform decoding processing on the first emotion feature and the encoded first fusion feature to obtain the second video.

In some embodiments, the first head feature is obtained based on the third video, and the apparatus further includes a first detecting portion, a second determining portion and a first masking portion. The first detecting portion is configured to detect a face of the first character in the first video to obtain face key points corresponding to at least one first video frame in the first video. The second determining portion is configured to determine, for each first video frame, a mouth area corresponding to the first video frame based on the face key points corresponding to the first video frame, and the first masking portion is configured to perform mask processing on the mouth area corresponding to each first video frame to obtain the third video.

In some embodiments, the apparatus further includes: a third determining portion configured to determine a first reference video frame from the first video. The first generating portion is further configured to: generate the second video including the first character based on the first head feature, a first identity feature of the first character and the first speech feature. The first identity feature is extracted from the first reference video frame.

In some embodiments, the face key points include a first key point characterizing an upper lip and a second key point characterizing a lower lip. The third determining portion is further configured to: determine, for each first video frame, a speech degree of the mouth in the first video frame based on the first key point and the second key point corresponding to the first video frame; and determine a first reference video frame having a greatest closure degree of mouth from the first video.

In some embodiments, the first generating portion is further configured to: generate a fourth video including the first character based on the first head feature and the first speech feature; and perform image fusion on a face area and a background area in at least one fourth video frame in the fourth video to obtain the second video.

An embodiment of the present disclosure provides an apparatus for model training, which includes various units and various portions included in each unit, and may be implemented by a processor in a computer device, or of course, the specific logic circuit. In the process of implementation, the processor may be a CPU, an MPU, a DSP, an FPGA, or the like.

FIG. 7B is a schematic structural diagram of a composition of an apparatus for model training according to an embodiment of the present disclosure. As shown in FIG. 7B, the apparatus for model training 720 includes a second acquiring portion 721, a second generating portion 722, a tuning portion 723, and a fourth determining portion 724.

The second acquiring portion 721 is configured to acquire first speech training data and first head training data of a second character. The first head training data is obtained by performing mask processing on a mouth area of the second character in a training video, and the first speech training data is obtained based on a training audio.

The second generating portion 722 is configured to input the first speech training data and the first head training data into a model to be trained to obtain a fifth video comprising the second character.

The tuning portion 723 is configured to determine a target loss by using the fifth video and perform parameter tuning on the model to be trained based on the target loss.

The fourth determining portion 724 is configured to determine that training of the model to be trained is completed in case where a speaking behavior of the second character in the fifth video matches the training audio.

In some embodiments, the model to be trained includes a rendering generation network, the first speech training data includes a second speech feature, and the first head training data includes a second head feature. The second generating portion is further configured to generate, by using the rendering generation network, the fifth video comprising the second character based on the second head feature and the second speech feature.

In some embodiments, the model to be trained includes a rendering generation network and at least one of a first feature extraction network and a second feature extraction network.

In case where the model to be trained includes the first feature extraction network rather than the second feature extraction network, the first head training data includes a sixth video obtained by performing mask processing on the mouth area of the second character in the training video, the first speech training data includes a second speech feature, and the second generating portion is further configured to: extract, by using the first feature extraction network, a second head feature of the second character from the sixth video; and generate, by using the rendering generation network, the fifth video including the second character based on the second head feature and the second speech feature.

In case where the model to be trained includes the second feature extraction network rather than the first feature extraction network, the first head training data includes the second head feature, the first speech training data includes the training audio, and the second generating portion is further configured to: perform, by using the second feature extraction network, feature extraction on the training audio to obtain the second speech feature; and generate, by using the rendering generation network, the fifth video including the second character based on the second head feature and the second speech feature.

In case where the model to be trained includes both the first feature extraction network and the second feature extraction network, the first head training data includes the sixth video, the first speech training data includes the training audio, and the second generating portion is further configured to: extract, by using the first feature extraction network, the second head feature of the second character from the sixth video; perform, by using the second feature extraction network, feature extraction on the training audio to obtain the second speech feature; and generate, by using the rendering generation network, the fifth video including the second character based on the second head feature and the second speech feature.

In some embodiments, the model to be trained includes the rendering generation network and the first feature extraction network. The tuning portion is further configured to perform parameter tuning on the rendering generation network and the first feature extraction network based on the target loss.

In some embodiments, the first feature extraction network includes a first encoder and a mapping sub-network, and the second head feature includes a second non-mouth area feature and a second head movement feature. The second generating portion is further configured to: perform, by using the first encoder, encoding processing on the sixth video to obtain the second non-mouth area feature; and map, by using the mapping sub-network, the second non-mouth area feature to a preset movement feature space to obtain the second head movement feature.

In some embodiments, the second generating portion is further configured to: fuse the second head feature and the second speech feature to obtain a second fusion feature; and generate, by using the rendering generation network, the fifth video based on the second fusion feature.

In some embodiments, the model to be trained includes the rendering generation network and the second feature extraction network, the second feature extraction network includes a second encoder and a third encoder, the second speech feature includes a second content feature and a second emotion feature. The second generating portion is further configured to: perform, by using the second encoder, encoding processing on the training audio to obtain the second content feature; and perform, by using the third encoder, encoding processing on the training audio to obtain the second emotion feature; fuse the second head feature and the second content feature to obtain the second fusion feature; and generate, by using the rendering generation network, the fifth video based on the second fusion feature and the second emotion feature.

In some embodiments, the rendering generation network includes a fourth encoder and a first decoder. The second generating portion is further configured to: perform, by using the fourth encoder, encoding processing on the second fusion feature to obtain an encoded second fusion feature; and perform, by using the first decoder, decoding processing on the second emotion feature and the encoded second fusion feature to obtain the fifth video.

In some embodiments, the model further comprises a face detection network. The apparatus further includes a second detecting portion and a second masking portion. The second detecting portion is configured to: detect, by using the face detection network, a face of the second character in the training video to obtain face key points corresponding to at least one second video frame in the training video, and determine, for each second video frame, a mouth area corresponding to the second video frame based on the face key points corresponding to the second video frame. The second masking portion is configured to perform mask processing on the mouth area corresponding to each second video frame to obtain the sixth video.

In some embodiments, the model further includes a third feature extraction network. The apparatus further comprises a fifth determining portion and a first extracting portion. The fifth determining portion is configured to determine a second reference video frame from the training video, and the first extracting portion is configured to extract, by using the third feature extraction network, a second identity feature of the second character from the second reference video frame. The second generating portion is further configured to generate, by using the rendering generation network, the fifth video including the second character based on the second head feature, the second identity feature and the second speech feature.

In some embodiments, the tuning portion is further configured to: determine a first loss based on the fifth video and a reference video corresponding to the training audio, determine the mouth area corresponding to at least one second video frame in the training video, and determine a mouth area corresponding to at least one third video frame in the fifth video; determine a second loss based on the respective mouth area corresponding to all the second video frame and the respective mouth area corresponding to all the third video frames, and determine the target loss based on the first loss and the second loss.

In some embodiments, the tuning portion is further configured to: extract a video segment and an audio segment which are matched with each other from the fifth video and the training audio, respectively; perform encoding processing on the video segment and the audio segment respectively to obtain a first encoded feature and a second encoded feature; obtain a third loss based on the first encoded feature and the second encoded feature; and determine the target loss based on the first loss, the second loss and the third loss.

In some embodiments, the tuning portion is further configured to: determine, by using a first discriminator, a true degree of at least one fourth video frame in the reference video and a true degree of at least one third video frame in the fifth video; determine a fourth loss based on the true degree of each fourth video frame and the true degree of each third video frame; and determine the target loss based on the first loss, the second loss, the third loss and the fourth loss.

In some embodiments, the tuning portion is further configured to: determine, for the each pair of adjacent fourth video frames in the reference video by using a second discriminator, a true adjacency degree between the adjacent fourth video frames of the pair; determine, for each pair of adjacent third video frames in the fifth video by using the second discriminator, a true adjacency degree between the adjacent third video frames of the pair; determine a fifth loss based on the true adjacency degree between the adjacent fourth video frames of all pairs and the true adjacency degree between the adjacent third video frames of all pairs; and determine the target loss based on the first loss, the second loss, the third loss, the fourth loss and the fifth loss.

The above description for the device embodiment is similar to the above description for the method embodiment, and has similar beneficial effects as the method embodiment. In some embodiments, the functions or modules included in the device provided by the embodiments of the present disclosure may be used to perform the methods described in the above-described method embodiments. For technical details not disclosed in the device embodiments of the present disclosure, reference may be made to the description in the method embodiments of the present disclosure for understanding.

In the embodiments and other embodiments of the present disclosure, the “portion” may be a circuit portion, a processor portion, a program or software portion, or the like, and may also be a unit, a module or may be non-modular in actual applications.

It should be noted that in the embodiment of the present disclosure, if the above-described method is implemented in the software function modules and sold or used as an independent product, the software function modules may be stored in a computer-readable storage medium. Based on this understanding, the technical solution of the present disclosure essentially or a part of the technical solution that contributes to the prior art may be embodied in the form of a software product, the software product is stored in a storage medium, and includes several instructions for causing a computer device (which may be a personal computer, server, or network device, etc.) to perform all or a part of the method described in various embodiments of the present disclosure. The above storage medium includes a USB disk, a removable hard disk, a Read-Only Memory (ROM), a magnetic disk or an optical disk or various mediums that can store a program code. Thus, the embodiments of the present disclosure are not limited to any specific hardware, software or firmware or any combination of the hardware, software or firmware.

The embodiments of the present disclosure provide a computer device including a processor and a memory. The memory is configured for storing a computer program which is able to run on the processor. The program, when executed by the processor, implements some or all of the operations of the above-described method.

The embodiments of the present disclosure provide a computer-readable storage medium on which a computer program is stored. The computer program is executed by a processor to implement some or all of the operations of the above-described method. The computer-readable storage medium may be transitory or non-transitory.

The embodiments of the present disclosure provide a computer program comprising a computer-readable code. When the computer-readable code is executed in the computer device, a processor in the computer device executes some or all of the operations for implementing the above-described method.

The embodiments of the present disclosure provide a computer program product including a computer program that, when executed by a processor, implements some or all of the operations of the above method.

The embodiments of the present disclosure provide a computer program product comprising a non-transitory computer-readable storage medium having a computer program stored thereon. The computer program, when read and executed by a computer, implements some or all of the operations of the above method. The computer program product may be implemented by means of hardware, software, or a combination thereof. In some embodiments, the computer program product is embodied as for example a computer storage medium, and in other embodiments, the computer program product is embodied as a software product, such as a Software Development Kit (SDK) or the like.

It should be pointed out here that the above description for the various embodiments emphasizes a difference of the embodiments, and regarding the similarities or commonalities thereof, reference may be made to each other. The embodiments of the device, the storage medium, the computer program, and the computer program product are described similarly to the description of the above method embodiments, and have similar beneficial effects as the method embodiments. Technical details not disclosed in the embodiments of the device, the storage medium, the computer program, and the computer program product of the present disclosure are understood with reference to the description in the method embodiments of the present disclosure.

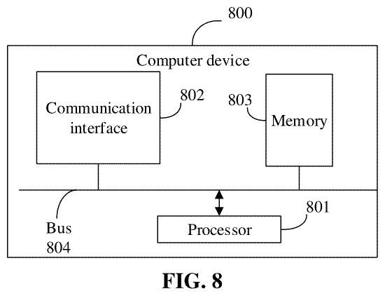

FIG. 8 is a schematic diagram of a hardware entity of a computer device according to an embodiment of the present disclosure. As shown in FIG. 8, the hardware entity of the computer device 800 includes a processor 801, a communication interface 802, and a memory 803.

The processor 801 generally controls an overall operation of the computer device 800.

The communication interface 802 may enable the computer device to communicate with another terminal or server over a network.

The memory 803 is configured to store instructions and applications executable by the processor 801, and may also store data (e.g., image data, audio data, speech communication data, and video communication data) to be processed or already processed by the processor 801 and various portions of the computer device 800, and the memory may be implemented by a FLASH or a Random Access Memory (RAM). Data transmission between the processor 801, the communication interface 802, and the memory 803 may be performed through the bus 804.

It is to be understood that references “an embodiment” or “one embodiment” throughout the specification mean that a particular feature, structure, or characteristic related to the embodiment is included in at least one embodiment of the present disclosure. Accordingly, the references “in an embodiment” or “in one embodiment” appearing throughout the specification do not necessarily refer to the same embodiment. Furthermore, these particular features, structures, or characteristics may be incorporated into one or more embodiments in any suitable manner. It should be understood that in various embodiments of the present disclosure, the sequence numbers of the above-described operations/processes do not mean the order of execution, and the order of execution of each operation/process should be determined by its function and internal logic, and should not constitute any limitation on the implementation process of the embodiments of the present disclosure. The above-described sequence numbers of the embodiments of the present disclosure are for description only, and do not represent the advantages and disadvantages of the embodiments.

It should be noted that, the terms “comprise”, “include”, or any other variation thereof herein are intended to encompass a non-exclusive inclusion such that a process, a method, an article or a device including a series of elements includes not only those elements, but also other elements that are not explicitly listed, or includes elements inherent to such the process, the method, the article or the device. Without further limitation, an element defined by the statement “comprising a . . . ” does not preclude the presence of additional identical elements in the process, the method, the article or the device that includes the elements.

In several embodiments provided by the present disclosure, it should be understood that the disclosed device and method may be implemented in other ways. The device embodiments described above are merely schematic. For example, the division of units is only a logical function division. In actual implementation, there may be other division methods. For example, multiple units or components may be combined, or may be integrated into another system, or some features may be ignored, or may not be implemented. Additionally, the coupling, or the direct coupling or the communicative connection of the components shown or discussed may be indirect coupling or communication connection through some interfaces, devices or units, and may be electrical, mechanical, or otherwise.

The units described above as separate components may or may not be physically separated, and the components displayed as units may or may not be physical units. The components displayed as units may be located in one place or distributed to multiple network elements. Some or all of the units may be selected according to actual needs to achieve the purpose of the present embodiment solution. In addition, in each embodiment of the present disclosure, the functional units may be all integrated into one processing unit, each unit may be separately used as one unit, or two or more units may be integrated into one unit. The above integrated unit may be implemented either in the form of hardware or in the form of a combination of hardware and software functional units.

Those skilled in the art will understand that all or part of the operations for implementing the above-described method embodiments may be completed by instructing the hardware by the program, and the aforementioned program may be stored in a computer-readable storage medium, and when the program is executed, the program implements the operations including the above-described method embodiments. The aforementioned storage medium includes various media capable of storing program codes, such as a removable storage device, a read only memory (ROM), a magnetic disk, an optical disk or the like.

Alternatively, if the above integrated unit of the present disclosure is implemented in the form of a software function module and sold or used as an independent product, the integrated unit may be stored in a computer-readable storage medium. Based on such understanding, the technical solution of the present disclosure essentially or a part of the technical solution that contributes to the prior art may be embodied in the form of a software product, the computer software product is stored in a storage medium, and includes several instructions for causing a computer device (which may be a personal computer, a server, or a network device, etc.) to perform all or a part of the method described in various embodiments of the present disclosure. The aforementioned storage medium includes various media capable of storing program codes, such as a removable storage device, a ROM, a magnetic disk, an optical disk, or the like.

The above description is merely the embodiments of the present disclosure, but the scope of protection of the present disclosure is not limited thereto, and any changes or substitutions that may be easily conceived by those skilled in the art within the technical scope of the present disclosure should be covered within the scope of protection of the present disclosure.

### INDUSTRIAL PRACTICALITY

The embodiments of the present disclosure disclose a method and an apparatus for video generation, a method and an apparatus for model training, a device, a storage medium, a computer program, and a computer program product. The method for video generation includes: acquiring a first speech feature and a first head feature of a first character, where the first head feature is obtained by performing mask processing on a mouth area of the first character in a first video, and the first speech feature is obtained based on a first audio; and generating a second video including the first character based on the first head feature and the first speech feature, where a speaking behavior of the first character in the second video matches the first audio. In an embodiment of the present disclosure, the first speech feature and a first head feature of a first character are acquired, and the second video including the first character is generated based on the first head feature and the first speech feature, and the speaking behavior of the first character in the second video is matched with the first audio. In this way, since the first head feature is obtained by performing mask processing on the mouth area of the first character in the first video, the first head feature is not affected by the mouth area, and is more reasonable and accurate, and the first speech feature is obtained based on the first audio, the appearance and posture of the head of the first character in the second video generated based on the first head feature and the first speech feature is more accurate, and the appearance and posture of the head is more matched with the first audio, and the overall speaking behavior of the character is more reasonable and realistic. In this way, the rationality and reality of the overall speaking behavior of the first character in the generated second video can be improved, and the quality of the generated second video can be improved.

1. A method for video generation, comprising:
acquiring a first speech feature and a first head feature of a first character, wherein the first head feature is obtained by performing mask processing on a mouth area of the first character in a first video, and the first speech feature is obtained based on a first audio; and
generating a second video comprising the first character based on the first head feature and the first speech feature, wherein a speaking behavior of the first character in the second video matches the first audio.

2. The method of claim 1, wherein the first head feature comprises a first non-mouth area feature and a first head movement feature,
the first non-mouth area feature is obtained by performing encoding processing on a third video, and the third video is obtained by performing mask processing on the mouth area of the first character in the first video; and
the first head movement feature is obtained by mapping the first non-mouth area feature to a preset movement feature space.

3. The method of claim 1, wherein the generating the second video comprising the first character based on the first head feature and the first speech feature comprises:
fusing the first head feature and the first speech feature to obtain a first fusion feature; and
generating the second video based on the first fusion feature.

4. The method of claim 3, wherein the first speech feature comprises a first content feature and a first emotion feature,
the fusing the first head feature and the first speech feature to obtain the first fusion feature comprises:
fusing the first header feature and the first content feature to obtain a first fusion feature, and
the generating the second video based on the first fusion feature comprises:
generating the second video based on the first fusion feature and the first emotion feature.

5. The method of claim 4, wherein the generating the second video based on the first fusion feature and the first emotion feature comprises:
performing encoding processing on the first fusion feature to obtain an encoded first fusion feature; and
performing decoding processing on the first emotion feature and the encoded first fusion feature to obtain the second video.

6. The method of claim 1, wherein the first head feature is obtained based on a third video, the method further comprises:
detecting a face of the first character in the first video to obtain face key points corresponding to at least one first video frame in the first video;
determining, for each of the first video frame, a mouth area corresponding to the first video frame based on the face key points corresponding to the first video frame; and
performing mask processing on the respective mouth area corresponding to all of the first video frame to obtain the third video.

7. The method of claim 6, further comprising:
determining a first reference video frame from the first video, and
the generating the second video comprising the first character based on the first head feature and the first speech feature comprises:
generating the second video comprising the first character based on the first head feature, a first identity feature of the first character and the first speech feature, wherein the first identity feature is extracted from the first reference video frame,
wherein the face key points comprise a first key point characterizing an upper lip and a second key point characterizing a lower lip;
the determining the first reference video frame from the first video comprises:
determining, for each of the first video frame, a closure degree of a mouth in the first video frame based on the first key point and the second key point corresponding to the first video frame; and
determining, from the first video, a first reference video frame with a greatest closure degree of mouth.

8. (canceled)

9. The method of claim 1, wherein the generating the second video comprising the first character based on the first head feature and the first speech feature comprises:
generating a fourth video comprising the first character based on the first head feature and the first speech feature; and
performing image fusion on a face area and a background area in at least one fourth video frame in the fourth video to obtain the second video.

10. A method for model training, comprising:
acquiring first speech training data and first head training data of a second character, wherein the first head training data is obtained by performing mask processing on a mouth area of the second character in a training video, and the first speech training data is obtained based on a training audio;
inputting the first speech training data and the first head training data into a model to be trained to obtain a fifth video comprising the second character;
determining a target loss by using the fifth video, and performing parameter tuning on the model to be trained based on the target loss; and
determining that training of the model to be trained is completed in case where a speaking behavior of the second character in the fifth video matches the training audio.

11. The method of claim 10, wherein the model to be trained comprises a rendering generation network, the first speech training data comprises a second speech feature, and the first head training data comprises a second head feature,
the inputting the first speech training data and the first head training data into the model to be trained to obtain the fifth video comprising the second character comprises:
generating, by using the rendering generation network, the fifth video comprising the second character based on the second head feature and the second speech feature.

12. The method of claim 10, wherein the model to be trained comprises a rendering generation network, and at least one of a first feature extraction network and a second feature extraction network,
in case where the model to be trained comprises the first feature extraction network and does not comprise the second feature extraction network, the first head training data comprises a sixth video obtained by performing mask processing on the mouth area of the second character in the training video, the first speech training data comprises a second speech feature, and the inputting the first speech training data and the first head training data into the model to be trained to obtain the fifth video comprising the second character comprises: extracting, by using the first feature extraction network, a second head feature of the second character from the sixth video; and generating, by using the rendering generation network, the fifth video comprising the second character based on the second head feature and the second speech feature; or
in case where the model to be trained comprises the second feature extraction network and does not comprise the first feature extraction network, the first head training data comprises the second head feature, the first speech training data comprises the training audio, and the inputting the first speech training data and the first head training data into the model to be trained to obtain the fifth video comprising the second character comprises: performing, by using the second feature extraction network, feature extraction on the training audio to obtain the second speech feature; and generating, by using the rendering generation network, the fifth video comprising the second character based on the second head feature and the second speech feature; or
in case where the model to be trained comprises the first feature extraction network and the second feature extraction network, the first head training data comprises the sixth video, the first speech training data comprises the training audio, and the inputting the first speech training data and the first head training data into the model to be trained to obtain the fifth video comprising the second character comprises: extracting, by using the first feature extraction network, the second head feature of the second character from the sixth video; performing, by using the second feature extraction network, feature extraction on the training audio to obtain the second speech feature; and generating, by using the rendering generation network, the fifth video comprising the second character based on the second head feature and the second speech feature.

13. The method of claim 12, wherein the model to be trained comprises the rendering generation network and the first feature extraction network,
the performing parameter tuning on the model to be trained based on the target loss comprises:
performing parameter tuning on the rendering generation network and the first feature extraction network based on the target loss.

14. The method of claim 12, wherein the first feature extraction network comprises a first encoder and a mapping sub-network, and the second head feature comprises a second non-mouth area feature and a second head movement feature,
the extracting, by using the first feature extraction network, the second head feature of the second character from the sixth video comprising:
performing, by using the first encoder, encoding processing on the sixth video to obtain the second non-mouth area feature; and
mapping, by using the mapping sub-network, the second non-mouth area feature to a preset movement feature space to obtain the second head movement feature.

15. The method of claim 12, wherein the generating, by using the rendering generation network, the fifth video comprising the second character based on the second head feature and the second speech feature comprises:
fusing the second head feature and the second speech feature to obtain a second fusion feature; and
generating, by using the rendering generation network, the fifth video based on the second fusion feature.

16. The method of claim 15, wherein the model to be trained comprises the rendering generation network and the second feature extraction network, the second feature extraction network comprises a second encoder and a third encoder, the second speech feature comprises a second content feature and a second emotion feature,
the performing, by using the second feature extraction network, feature extraction on the training audio to obtain the second speech feature comprises: performing, by using the second encoder, encoding processing on the training audio to obtain the second content feature; and performing, by using the third encoder, encoding processing on the training audio to obtain the second emotion feature, and
the fusing the second head feature and the second speech feature to obtain the second fusion feature comprises: fusing the second head feature and the second content feature to obtain the second fusion feature, and
the generating, by using the rendering generation network, the fifth video based on the second fusion feature comprises: generating, by using the rendering generation network, the fifth video based on the second fusion feature and the second emotion feature.

17. The method of claim 16, wherein the rendering generation network comprises a fourth encoder and a first decoder,
the generating, by using the rendering generation network, the fifth video based on the second fusion feature and the second emotion feature comprises:
performing, by using the fourth encoder, encoding processing on the second fusion feature to obtain an encoded second fusion feature; and
performing, by using the first decoder, decoding processing on the second emotion feature and the encoded second fusion feature to obtain the fifth video.

18. The method of claim 12, wherein the model further comprises a face detection network, and the method further comprises:
detecting, by using the face detection network, a face of the second character in the training video to obtain face key points corresponding to at least one second video frame in the training video, and determining, for each of the second video frame by using the face detection network, a mouth area corresponding to the second video frame based on the face key points corresponding to the second video frame; and
performing mask processing on the respective mouth area corresponding to all of the second video frame to obtain the sixth video.

19. The method of claim 18, wherein the model further comprises a third feature extraction network, and the method further comprises:
determining a second reference video frame from the training video; and
extracting, by using the third feature extraction network, a second identity feature of the second character from the second reference video frame, and
the generating, by using the rendering generation network, the fifth video comprising the second character based on the second head feature and the second speech feature comprises: generating, by using the rendering generation network, the fifth video comprising the second character based on the second head feature, the second identity feature and the second speech feature.

20. The method of claim 10, wherein the determining the target loss by using the fifth video comprises:
determining a first loss based on the fifth video and a reference video corresponding to the training audio;
determining a respective mouth area corresponding to at least one second video frame in the training video, and determining a respective mouth area corresponding to at least one third video frame in the fifth video;
determining a second loss based on the respective mouth area corresponding to all of the second video frame and the respective mouth area corresponding to all of the third video frame; and
determining the target loss based on the first loss and the second loss.

21.-25. (canceled)

26. A computer device comprising a processor and a memory having a computer program executable on the processor stored thereon, wherein the program, when executed by the processor, implements:
acquiring a first speech feature and a first head feature of a first character, wherein the first head feature is obtained by performing mask processing on a mouth area of the first character in a first video, and the first speech feature is obtained based on a first audio; and
generating a second video comprising the first character based on the first head feature and the first speech feature, wherein a speaking behavior of the first character in the second video matches the first audio.

27.-29. (canceled)
